(19) United States
(12) Patent Application Publication
(10) Pub. No.: US 2025/0181423 A1
(43) Pub. Date: Jun. 5, 2025

(54) SYSTEMS AND METHODS FOR ADMISSION CONTROL FOR MULTI CONSENSUS-BASED REPLICATION

(71) Applicant: Cockroach Labs, Inc., New York, NY (US)

(72) Inventors: Sumeer Kumar Bhola, Brooklyn, NY (US); Tobias Grieger, Bonn (DE); Irfan Sharif, Toronto (CA)

(21) Appl. No.: 18/529,602

(22) Filed: Dec. 5, 2023

(51) Int. Cl. G06F 9/54; G06F 9/48; G06F 9/50

(52) U.S. Cl. CPC G06F 9/54; G06F 9/4881; G06F 9/5005; G06F 2209/5011; G06F 2209/544; G06F 2209/548

(57) ABSTRACT

Systems and methods for controlling resource utilization for a consensus-based distributed group of replicas are provided. A leader node can receive a write request originating from a tenant and comprising instructions to write to data of replicas of a range. The leader node stores a leader replica, follower nodes each store a follower replica, and the leader node is configured to coordinate a consensus protocol for executing the instructions. The leader node and the follower nodes each correspond to at least one of a plurality of token pools. Sizes of the token pools are determined based on receiving the write request. The write request is evaluated based on the sizes of the token pools by determining a size of the write request and generating a log entry for the write request. The write request is executed using the log entry by writing to the data of the replicas.

### FIELD OF TECHNOLOGY

The present disclosure relates generally to methods and systems for controlling resource utilization at a distributed system and more particularly, to controlling resource utilization for a consensus-based distributed group of replicas stored by the distributed system.

### BACKGROUND

In some cases, relational databases can apply replication to ensure data survivability, where data is replicated among one or more computing devices (“nodes”) of a group of computing devices (“cluster”). A relational database may store data within one or more ranges, where a range can include one or more key-value (KV) pairs and can be replicated among one or more nodes of the cluster. A range may be a partition of a data table (“table”), where a table may include one or more ranges. The database may receive requests (e.g., such as read or write requests originating from client devices) directed to data and/or schema objects stored by the database.

In some cases, for failure tolerance and data survivability, a range can be replicated across two or more nodes included in the cluster to maintain data availability in the event of a node failure. As described further herein, a consensus protocol (e.g., Raft, Paxos, etc.) can be used to apply updates to the range and the data included in the range, such that at least a threshold number (e.g., a majority number) of replicas can be required to agree to commit an update to a range to modify a state of the replica (e.g., modify values corresponding to particular keys). Using consensus-based state machine replication, each of the replicas of a particular range maintains a respective log of updates to the state of a replica, where the consensus protocol ensures that the log includes the same updates and in the same order across each of the replicas of the range. When an update in the log is considered “committed” by the consensus protocol, each replica can apply the update included in the log to its respective local copy of the replica state. The application of the update by the replicas can be deterministic, thereby ensuring that all replicas of the range that apply the same sequence of updates will have the same resulting state.

Consensus-based state machine replication (e.g., using a log at each replica) can be a common fault tolerance mechanism used in distributed computing systems. In some cases, such distributed computing systems can include distributed database systems (e.g., NoSQL database systems, SQL database systems, etc.) including a number of nodes storing a very large database (e.g., including a number of terabytes or petabytes). Such a database cannot feasibly be stored by replicas solely in K nodes, where K is the replication factor, such as 3. When K=3, the distributed computing system can tolerate a failure of one node storing a replica, and when K=5, the distributed computing system can tolerate a failure (e.g., unavailability) of two nodes each storing a replica, as such replication factors allow at least a majority number of the replicas agree to commit updates to the replicas via a distributed consensus protocol. These distributed database systems can partition the database state using methods such as hash partitioning and range partitioning. Each range formed by the partitioning can operate according to a respective consensus protocol, and the replicas of the range that participate in the consensus protocol can form a group referred to herein as a “consensus group”. The state size of a range can be selectable and can vary, for example, from 512 megabytes (MB) to tens of gigabytes (GB).

In some cases, an individual node included in such a distributed database system can store replicas corresponding to a number of different ranges. For example, for a range size of 10 GB and a node including a 1 terabyte (TB) non-volatile storage medium (e.g., solid state drive storage, disk storage, etc.), the node could store up to 100 ranges. Accordingly, the ranges stored by an individual node share the physical computing resources of the node, such as a central processing unit (CPU), non-volatile storage (e.g., solid state drive storage, disk storage, etc.), and volatile storage (e.g., memory such as random access memory (RAM)) of the node.

In some case, for a distributed database system, a workload stored by the distributed database systems can include one or more ranges and can be associated with (e.g., operated by) a particular tenant (e.g., entity, customer, organization, etc.). Further, a tenant can be associated with and operate one or more workloads stored by nodes of the distributed database system. In some cases, multiple workloads each including one or more ranges may share the same computing resources (e.g., nodes), such that replicas of ranges corresponding to different workloads can be stored on the same node. In multi-tenant systems, the workloads stored by the nodes can be associated with multiple tenants, such that multiple tenants access and interact with their respective workloads that can be stored by one or more of the same nodes. Accordingly, providing performance isolation between workloads sharing the computing resources of the distributed database system can be desirable, particularly when workloads can correspond to different tenants (e.g., as in multi-tenant systems). In some cases, strict prioritization techniques and/or fair-sharing techniques (e.g., based on weights assigned to workloads and/or tenants associated with workloads) can be used to provide performance isolation in a distributed database system. For example, conventional distributed database systems can apply performance isolation techniques at a replica (e.g., leader replica) at which a request (e.g., a read request and/or write request) originates. However, conventional systems fail to apply performance isolation techniques at replicas (e.g., follower replicas) to which a request is replicated despite these replicas utilizing a higher share of computing resources of nodes than the replica at which the request originates. As an example, a distributed database system may include a number of ranges, where (i) each range has K=5 replicas, and (ii) the leader replica of each range is uniformly distributed across all of the nodes (e.g., five nodes) of the system. For such a system, 80% (⅘) of the ranges stored by a particular node of the nodes are follower replicas of the ranges and 20% (⅕) of the ranges stored by a particular node of the nodes are leader replicas of the ranges, such that follower replicas provide a majority of resource utilization at each node. By failing to apply performance isolation techniques at replicas to which requests are replicated, conventional systems fail to account for the resource utilization of up to 80% of the replicas of ranges, resulting in poor performance isolation when resource utilization is high and the partitions are operated by different tenants. For these reasons, conventional systems (i) provide poor performance isolation between workloads and/or (ii) can require over-provisioned computing resources to avoid high utilization of the resources at nodes. Accordingly, improved systems and methods for controlling resource utilization are desired that can adequately provide performance isolation between workloads for consensus-based replication techniques.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

Methods and systems for controlling resource utilization for a consensus-based distributed group of replicas are disclosed. In one aspect, embodiments of the present disclosure feature a method for controlling resource utilization for a consensus-based distributed group of replicas. According to one embodiment, the method includes receiving, by a leader node of a plurality of nodes, a first write request (i) originating from a first tenant and (ii) including first instructions to write to data of three or more replicas of a first range, where the leader node stores a leader replica of the replicas, where at least two follower nodes of the nodes each store a follower replica of the replicas, where the leader node is configured to coordinate a consensus protocol for executing the first instructions of the first write request, where the leader node and the follower nodes each correspond to at least one of a plurality of token pools associated with the leader node, the follower nodes, and the first tenant. The method includes determining, based on receiving the first write request, a plurality of sizes of the token pools. The method includes evaluating, based on the sizes of the token pools, the first write request by (i) determining a size of the first write request and (ii) generating a first log entry for the first write request. The method includes executing, using the first log entry, the first write request by writing to the data of the leader replica and the follower replicas based on the first instructions.

Various embodiments of the method can include one or more of the following features. In some cases, the method may also include where the first write request originates from a client device associated with the first tenant. The method may also include where the leader node stores the token pools corresponding to the leader node and the follower nodes. The method may also include where the token pools correspond to a first workload including one or more ranges stored by the nodes, where the one or more ranges comprise the first range. The method may also include comparing the sizes of the token pools to a threshold size, where the evaluating the first write request further includes evaluating the first write request when each of the sizes is greater than the threshold size. The method may also include deducting, based on the evaluation of the first write request, the size of the first write request from each of the token pools. The method may also include recording first metadata for the first log entry in a ledger stored by the leader node, where the first metadata includes an indication of the size of the first write request.

The method may also include where the leader node operates an admission queue, where the size of the at least one token pool corresponding to the leader node is based on a utilization of physical resources of the leader node. The method may also include queueing first metadata for the first log entry in the admission queue, where the admission queue is configured to queue metadata for a plurality of log entries corresponding to one or more tenants, where the metadata for the plurality of log entries includes the first metadata for the first log entry, and where the one or more tenants comprise the first tenant. The method may also include dequeuing the first metadata for the first log entry from the admission queue based on the utilization of the physical resources of the leader node. The method may also include adding, based on the dequeuing, the size of the first write request to the at least one token pool corresponding to the leader node.

The method may also include where a first follower node of the follower nodes operates an admission queue, where the size of the at least one token pool corresponding to the first follower node is based on a utilization of physical resources of the first follower node. Each of the follower nodes may operate a respective admission queue as described herein. The method may also include queueing first metadata for the first log entry in the admission queue, where the admission queue is configured to queue metadata for a plurality of log entries corresponding to one or more tenants, where the metadata for the plurality of log entries includes the first metadata for the first log entry, and where the one or more tenants comprise the first tenant. The method may also include dequeuing the first metadata for the first log entry from the admission queue based on the utilization of the physical resources of the first follower node. The method may also include sending, from the first follower node to the leader node and based on the dequeuing, second instructions configured to cause addition of the size of the first write request to the at least one token pool corresponding to the first follower node. The method may also include receiving, by the leader node, the second instructions. The method may also include adding, based on the receipt of the second instructions, the size of the first write request to the at least one token pool corresponding to the first follower node.

The method may also include where the executing the first write request further includes sending, from the leader node to the follower nodes, the first log entry, where the first log entry includes an indication of the first instructions of the first write request, and based on a majority of the leader node and the follower nodes recording the first log entry to a respective write log stored by each of the leader node and the follower nodes, writing to the data of the leader replica and the follower replicas based on the first log entry. The method may also include where the physical resources of the leader node comprise one or more of: a processor, non-volatile storage, and volatile memory. The method may also include where the admission queue is configured to order the metadata for the plurality of log entries for dequeuing based on at least one of: (i) a respective priority level of each the plurality of log entries, and (ii) a respective priority of each of the one or more tenants. The method may also include where the physical resources of the first follower node comprise one or more of: a processor, non-volatile storage, and volatile memory. The method may also include where the admission queue is configured to order the metadata for the plurality of log entries for dequeuing based on at least one of: (i) a respective priority level of each the plurality of log entries, and (ii) a respective priority of each of the one or more tenants. The method may also include adding, based on a failure of the first follower node, the size of the first write request to the at least one token pool corresponding to the first follower node.

In another aspect, the present disclosure features a system for controlling resource utilization for a consensus-based distributed group of replicas. The system can include corresponding computer systems (e.g., servers), apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The above and other preferred features, including various novel details of implementation and combination of events, will now be more particularly described with reference to the accompanying figures and pointed out in the claims. It will be understood that the particular methods and systems described herein are shown by way of illustration only and not as limitations. As will be understood by those skilled in the art, the principles and features described herein may be employed in various and numerous embodiments without departing from the scope of the present disclosure. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of the present disclosure.

The foregoing Summary, including the description of some embodiments, motivations therefore, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1 (“FIG. 1”) shows an illustrative distributed computing system, according to some embodiments.

FIG. 2A shows an example of execution of a read transaction at the computing system, according to some embodiments.

FIG. 2B shows an example of execution of a write transaction at the computing system, according to some embodiments.

FIG. 3 shows an exemplary flowchart of a method for processing a write request using a consensus protocol, according to some embodiments.

FIG. 4 shows an exemplary flowchart of a method for processing a write request using a consensus protocol and admission control techniques, according to some embodiments.

FIG. 5 is a block diagram of an example computer system.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Methods and systems for controlling computing resource utilization for a consensus-based distributed group of replicas of a range are disclosed. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

### Motivation for Some Embodiments

As described herein, conventional distributed computing systems fail to provide performance isolation techniques between workloads for follower replicas to which requests are replicated by a leader replica. By failing to account for resource utilization by follower replicas, conventional systems promote poor performance isolation between workloads when resource utilization is high. Accordingly, in conventional systems, a first workload including a first follower replica stored by a node can negatively impact performance (e.g., latency) for a second workload corresponding to a leader replica or a second follower replica stored by the node via write requests directed to the first follower replica, as such write requests can disproportionately utilize physical computing resources (e.g., CPU, non-volatile storage, volatile memory, etc.) of the node. For example, write requests executing at a node storing a follower replica of a first range associated with a first workload or tenant can delay execution of second write requests waiting to execute at the node for a replica (e.g., leader replica or follower replica) of a second range associated with a second workload or tenant. To overcome these deficiencies, conventional systems can be required to over-provision computing resources to (i) avoid high utilization of the computing resources at nodes and (ii) mitigate performance impacts between workloads. Accordingly, improved systems and methods for controlling resource utilization for consensus-based distributed groups of replicas are provided.

To provide admission control for execution of write requests by nodes storing consensus groups of replicas, token pools are introduced for use among the nodes of the consensus groups, where the token pools can provide performance isolation to execution of write requests by the nodes. Each token pool may include attributes identifying particular nodes storing replicas of a range that form a consensus group and a particular tenant associated with the replicas, where the attributes identify an originating node (e.g., a leader node storing a replica of the consensus group) for the write request (referred to as an <originating node> attribute), a replica node (e.g., a leader node or a follower node storing a replica of the consensus group) for the write request (referred to as a <replica node> attribute) at which the write request is applied, and a tenant from which the write request originated (referred to as a <tenant> attribute). Importantly, token pools may be defined as corresponding to a particular node from the nodes storing replicas of a consensus group and a particular tenant associated with the replicas of the consensus group (e.g., the tenant manages the data stored by the replicas), such that replicas for different workloads that are stored by the same node and associated with the same tenant can share a token pool. While some embodiments of token pools are described herein as being associated with a tenant, in some cases, the token pools may additionally or alternatively be defined as associated with a particular workload corresponding to a tenant, such that replicas for different workloads (e.g., corresponding to a same tenant or different tenants) that are stored by the same node do not share a same token pool. As an example, each token pool may include attributes identifying particular nodes storing replicas of a range that form a consensus group and a particular workload associated with the replicas, where the attributes identify an originating node (e.g., leader node) for the write request (referred to as an <originating node> attribute), a replica node (e.g., leader node or follower node) for the write request (referred to as a <replica node> attribute) at which the write request is applied, and a workload including the range to which the write request is directed (referred to as a <workload> attribute). Execution of write requests according to a consensus protocol as described herein can cause consumption (e.g., subtraction) and replenishing (e.g., addition) of tokens from a group of token pools, thereby (i) controlling rates at which write requests are processed and (ii) ensuring fairness between tenants operating ranges on nodes sharing physical computing resources. Further, virtual admission queues are introduced to control the replenishing of tokens to the group of token pools. In some cases, virtual admission queues can prioritize replenishing tokens for particular priority levels of requests, tenants, workloads, and/or transactional timestamps, thereby promoting fair use of physical computing resources at nodes participating in consensus protocols to commit write operations as described herein. Both token pools and virtual admission queues can integrate with the consensus protocol executing among nodes storing replicas of ranges to prevent overutilization of physical computing resources, while maintaining inter-tenant and/or inter-workload fairness. While application of token pools and virtual admission queues are described herein with respect to a Raft consensus protocol, a person of ordinary skill in the art would appreciate that the techniques described herein may be applied to replicas of data that operate according to any type of distributed consensus protocol.

### Terms

“Cluster” generally refers to a deployment of computing devices that comprise a database. A cluster may include computing devices (e.g., computing nodes) that are located in one or more geographic locations (e.g., data centers). The one or more geographic locations may be located within a single geographic region (e.g., eastern United States, central United States, etc.) or more than one geographic location. For example, a cluster may include computing devices that are located in both the eastern United States and western United States, with 2 data centers in the eastern United states and 4 data centers in the western United States.

“Node” generally refers to an individual computing device (e.g., server) that is a part of a cluster. A node may join with one or more other nodes to form a cluster. One or more nodes that comprise a cluster may store data (e.g., tables, indexes, etc.) in a map of KV pairs. A node may store a “range”, which can be a subset of the KV pairs (or all of the KV pairs depending on the size of the range) stored by the cluster. A range may also be referred to as a “shard”, “tablet”, and/or “partition”. A table and its secondary indexes can be mapped to one or more ranges, where each KV pair in a range may represent a single row in the table (which can also be referred to as the primary index because the table is sorted by the primary key) or a single row in a secondary index. Based on the range reaching or exceeding a threshold storage size, the range may split into two ranges. For example, based on reaching 512 mebibytes (MiB) in size, the range may split into two ranges. Successive ranges may split into one or more ranges based on reaching or exceeding a threshold storage size.

“Index” generally refers to a copy of the rows corresponding to a single table, where the rows are sorted by one or more columns (e.g., a column or a set of columns) of the table. Each index may correspond and/or otherwise belong to a single table. In some cases, an index may include a type. An example of a first type of index may be a primary index. A primary index may be an index on row-identifying primary key columns. A primary key constraint may be applied to one or more columns of a table to uniquely identify each row of the table, such that the primary key adds structure to table data. For a column configured with a primary key constraint, values stored in the column(s) must uniquely identify each row. One or more columns of a table may be configured with a primary key constraint and the database that includes the table may automatically create an index (referred to as a primary index) for the primary key column(s). A primary key may be defined for each table stored by a database as described herein. An example of a second type of index may be a secondary index. A secondary index may be defined on non-primary key columns of a table. A table that does not include a defined primary index may include a hidden row identifier (ID) (e.g., referred to as rowid) column that uniquely identifies each row of the table as an implicit primary index.

“Replica” generally refers to a copy of a range. A range may be replicated at least a

threshold number of times to produce a number of replicas. For example and by default, a range may be replicated 3 times as 3 distinct replicas. Each replica of a range may be stored on a distinct node of a cluster. For example, 3 replicas of a range may each be stored on a different node of a cluster. In some cases, a range may be required to be replicated a minimum of 3 times to produce at least 3 replicas. In some cases, ranges may be replicated based on data survivability preferences as described further in U.S. patent application Ser. Nos. 17/978,752 and 18/365,888, which are hereby incorporated by reference herein in their entireties.

“Leaseholder” or “leaseholder replica” generally refers to a replica of a range that is configured to hold the lease for the replicas of the range. The leaseholder may receive and/or coordinate read transactions and write transactions directed to one or more KV pairs stored by the range. “Leaseholder node” may generally refer to the node of the cluster that stores the leaseholder replica. The leaseholder may receive read transactions and serve reads to client devices indicated by the read transactions. Other replicas of the range that are not the leaseholder may receive read transactions and route the read transactions to the leaseholder, such that the leaseholder can serve the read based on the read transaction.

“Raft group” or “consensus group” generally refers to a group of the replicas for a particular range. The consensus group may only include voting replicas for the range and the consensus group may participate in a distributed consensus protocol and include operations as described herein.

“Raft leader” or “leader” generally refers to a replica of the range that is a leader for managing write transactions for a range. In some cases, the leader and the leaseholder are the same replica for a range (e.g., leader is inclusive of leaseholder and/or leaseholder is inclusive of leader). In other cases, the leader and the leaseholder are not the same replica for a range. “Raft leader node” or “leader node” generally refers to a node of the cluster that stores the leader. The leader may determine that a threshold number of the replicas of a range agree to commit a write transaction prior to committing the write transaction. In some cases, the threshold number of the replicas of the range may be a majority of the replicas of the range.

“Follower” generally refers to a replica of the range that is not the leader. “Follower node” may generally refer to a node of the cluster that stores the follower replica. Follower replicas may receive write requests corresponding to transactions from the leader replica. The leader replica and the follower replicas of a range may constitute voting replicas that participate in a distributed consensus protocol and included operations (also referred to as “Raft protocol” and “Raft operations”) as described herein.

“Raft log” and “write log” generally refers to a time-ordered log of log entries indicative of write requests (e.g., included in transactions) to a range, where the log of log entries indicate write requests and the included updates to a state of the range agreed to by at least a threshold number of the replicas of the range. Each replica of a range may include a Raft log stored on the node that stores the replica. A Raft log for a replica may be stored on persistent storage (e.g., non-volatile storage such as disk storage, solid state drive (SSD) storage, etc.). A Raft log may be a source of truth for replication among nodes for a range. Each log entry included in the Raft log may be ordered based on a timestamp at which the log entry was added to the Raft log, such that application order of the updates to each replica is the same for each replica of the range.

“Consistency” generally refers to causality and the ordering of transactions within a distributed system. Consistency defines rules for operations within the distributed system, such that data stored by the system will remain consistent with respect to read and write requests originating from different sources.

“Consensus” generally refers to a threshold number of replicas for a range, based on receiving a write transaction, acknowledging a write transaction. In some cases, the threshold number of replicas may be a majority of replicas for a range. Consensus may be achieved even if one or more nodes storing replicas of a range are offline, such that the threshold number of replicas for the range can acknowledge the write transaction. Based on achieving consensus, data modified by the write transaction may be stored within the range(s) targeted by the write transaction.

“Replication” generally refers to creating and distributing copies (e.g., replicas) of the data stored by the cluster. In some cases, replication can ensure that replicas of a range remain consistent among the nodes that each comprise a replica of the range. In some cases, replication may be synchronous such that write transactions are acknowledged and/or otherwise propagated to a threshold number of replicas of a range before being considered committed to the range.

### Database Overview

A database stored by a cluster of nodes may operate based on one or more remote procedure calls (RPCs). The database may be comprised of a KV store distributed among the nodes of the cluster. In some cases, the RPCs may be SQL RPCs. In other cases, RPCs based on other programming languages may be used. Nodes of the cluster may receive SQL RPCs from client devices. After receiving SQL RPCs, nodes may convert the SQL RPCs into operations that may operate on the distributed KV store.

In some embodiments, as described herein, the KV store of the database may be comprised of one or more ranges. A range may be a selected storage size. For example, a range may be 512 MiB. Each range may be replicated to more than one node to maintain data survivability. For example, each range may be replicated to at least 3 nodes. By replicating each range to more than one node, if a node fails, replica(s) of the range would still exist on and be available on other nodes such that the range can still be accessed by client devices and replicated to other nodes of the cluster.

In some embodiments, operations directed to KV data as described herein may be executed by one or more transactions. In some cases, a node may receive a read transaction from a client device. A node may receive a write transaction from a client device. In some cases, a node can receive a read transaction or a write transaction from another node of the cluster. For example, a leaseholder node may receive a read transaction from a node that originally received the read transaction from a client device. In some cases, a node can send a read transaction to another node of the cluster. For example, a node that received a read transaction, but cannot serve the read transaction may send the read transaction to the leaseholder node. In some cases, if a node receives a read or write transaction that it cannot directly serve, the node may send and/or otherwise route the transaction to the node that can serve the transaction.

In some embodiments, modifications to the data of a range may rely on a consensus protocol (e.g., Raft protocol) to ensure a threshold number of replicas of the range agree to commit the change. The threshold may be a majority of the replicas of the range. The consensus protocol may enable consistent reads of data stored by a range.

In some embodiments, data may be written to and/or read from a storage device of a node using a storage engine that tracks the timestamp associated with the data. By tracking the timestamp associated with the data, client devices may query for historical data from a specific period of time (e.g., at a specific timestamp). A timestamp associated with a key corresponding to KV data may be assigned by a gateway node that received the transaction that wrote and/or otherwise modified the key. For a transaction that wrote and/or modified the respective key, the gateway node (e.g., the node that initially receives a transaction) may determine and assign a timestamp to the transaction based on time of a clock of the node (e.g., at the timestamp indicated by the clock when the transaction was received by the gateway node). The transaction may assign the timestamp to the KVs that are subject to the transaction. Timestamps may enable tracking of versions of KVs (e.g., through multi-version concurrency control (MVCC) as to be described herein) and may provide guaranteed transactional isolation. In some cases, additional or alternative methods may be used to assign versions and/or timestamps to keys and respective values.

In some embodiments, a “table descriptor” may correspond to each table of the database, where the table descriptor may contain the schema of the table and may include information associated with the table. Each table descriptor may be stored in a “descriptor table”, where each version of a table descriptor may be accessed by nodes of a cluster. In some cases, a “descriptor” may correspond to any suitable schema or subset of a schema, where the descriptor may contain the schema or the subset of the schema and may include information associated with the schema (e.g., a state of the schema). Examples of a descriptor may include a table descriptor, type descriptor, database descriptor, and schema descriptor. A view and/or a sequence as described herein may correspond to a table descriptor. Each descriptor may be stored by nodes of a cluster in a normalized or a denormalized form. Each descriptor may be stored in a KV store by nodes of a cluster. In some embodiments, the contents of a descriptor may be encoded as rows in a database (e.g., SQL database) stored by nodes of a cluster. Descriptions for a table descriptor corresponding to a table may be adapted for any suitable descriptor corresponding to any suitable schema (e.g., user-defined schema) or schema element as described herein. In some cases, a database descriptor of a database may include indications of a primary region and one or more other database regions configured for the database.

In some embodiments, database architecture for the cluster of nodes may be comprised of one or more layers. The one or more layers may process received SQL RPCs into actionable processes to access, modify, store, and return data to client devices, while providing for data replication and consistency among nodes of a cluster. The layers may comprise one or more of: a SQL layer, a transactional layer, a distribution layer, a replication layer, and a storage layer.

In some cases, the SQL layer of the database architecture exposes a SQL application programming interface (API) to developers and converts high-level SQL statements into low-level read and write requests to the underlying KV store, which are passed to the transaction layer. The transaction layer of the database architecture can implement support for atomic, consistent, isolated, and durable (ACID) transactions by coordinating concurrent operations. The distribution layer of the database architecture can provide a unified view of a cluster's data. The replication layer of the database architecture can copy data between nodes and ensure consistency between these copies by implementing a consensus protocol (e.g., consensus algorithm). The storage layer may commit writes from the Raft log to disk (e.g., a non-volatile computer-readable storage medium on a node), as well as return requested data (e.g., read data) to the replication layer.

### Transaction Layer

In some embodiments, the database architecture for a database stored by a cluster (e.g., cluster 102) of nodes may include a transaction layer. The transaction layer may enable ACID semantics for transactions within the database. The transaction layer may receive binary KV operations from the SQL layer and control KV operations sent to a distribution layer. In some cases, a storage layer of the database may use MVCC to maintain multiple versions of keys stored in ranges of the cluster. For example, each key stored in a range may have a stored MVCC history including respective versions of the key, values for the versions of the key, and/or timestamps at which the respective versions were written and/or committed.

In some embodiments, for write transactions, the transaction layer may generate one or more locks. A lock may represent a provisional, uncommitted state for a particular value of a KV pair. The lock may be written as part of the write transaction. The database architecture described herein may include multiple lock types. In some cases, the transactional layer may generate unreplicated locks, which may be stored in an in-memory lock table (e.g., stored by volatile, non-persistent storage of a node) that is specific to the node storing the replica on which the write transaction executes. An unreplicated lock may not be replicated other replicas based on a consensus protocol as described herein. In other cases, the transactional layer may generate one or more replicated locks (referred to as “intents” or “write intents”). An intent may be a persistent, provisional value written by a transaction before the transaction commits that is stored in persistent storage (e.g., non-volatile storage such as disk storage, SSD storage, etc.) of nodes of the cluster. Each KV write performed by a transaction can initially be an intent, which includes a provisional version and a reference to the transaction's corresponding transaction record. An intent may differ from a committed value by including a pointer to a transaction record of a transaction that wrote the intent. In some cases, the intent functions as an exclusive lock on the KV data of the replica stored on the node on which the write transaction executes, thereby preventing conflicting read and write requests having timestamps greater than or equal to a timestamp corresponding to the intent (e.g., the timestamp assigned to the transaction when the intent was written). An intent may be replicated to other nodes of the cluster storing a replica of the range based on the consensus protocol as described herein. An intent for a particular key may be included in an MVCC history corresponding to the key, such that a reader of the key can distinguish the intent from other versions of committed MVCC values stored in persistent storage for the key.

In some embodiments, each transaction directed to the cluster may have a unique replicated KV pair (referred to as a “transaction record”) stored on a range stored by the cluster. The transaction for a record may be added and stored in a replica of a range on which a first operation of the write transaction occurs. The transaction record for a particular transaction may store metadata corresponding to the transaction. The metadata may include an indication of a status of a transaction and a unique identifier (ID) corresponding to the transaction. The status of a transaction may be one of: “pending” (also referred to as “PENDING”), staging (also referred to as “STAGING”), “committed” (also referred to as “COMMITTED”), or “aborted” (also referred to as “ABORTED”) as described herein. A pending state may indicate that the transaction is in progress. A staging state may be used to enable a parallel commit protocol. A committed state may indicate that the transaction has committed and the write intents written by the transaction have been recorded by follower replicas. An aborted state may indicate the write transaction has been aborted and the values (e.g., values written to the range) associated with the write transaction may be discarded and/or otherwise dropped from the range. As write intents are generated by the transaction layer as a part of a write transaction, the transaction layer may check for newer (e.g., more recent) committed values at the KVs of the range on which the write transaction is operating. If newer committed values exist at the KVs of the range, the write transaction may be restarted. Alternatively, if the write transaction identifies write intents at the KVs of the range, the write transaction may proceed as a transaction conflict as to be described herein. The transaction record may be addressable using the transaction's unique ID, such that requests can query and read a transaction's record using the transaction's ID.

In some embodiments, for read transactions, the transaction layer may execute a read transaction at KVs of a range indicated by the read transaction. The transaction layer may execute the read transaction if the read transaction is not aborted. The read transaction may read MVCC values at the KVs of the range. Alternatively, the read transaction may read intents written at the KVs, such that the read transaction may proceed as a transaction conflict as to be described herein.

In some embodiments, to commit a write transaction, the transaction layer may determine the transaction record of the write transaction as it executes. The transaction layer may restart the write transaction based on determining the state of the write transaction indicated by the transaction record is aborted. Alternatively, the transaction layer may determine the transaction record to indicate the state as pending or staging. Based on the transaction record indicating the write transaction is in a pending state, the transaction layer may set the transaction record to staging and determine whether the write intents of the write transaction have succeeded (e.g., succeeded by replication to the other nodes storing the range). If the write intents have succeeded, the transaction layer may report the commit of the transaction to the client device that initiated the write transaction.

In some embodiments, based on committing a write transaction, the transaction layer may cleanup the committed write transaction. A coordinating node to which the write transaction was directed may cleanup the committed write transaction via the transaction layer. A coordinating node may be a node that stores a replica of a range that is the subject of the transaction. In some cases, a coordinating node may be the gateway node for the transaction. The coordinating node may track a record of the KVs that were the subject of the write transaction. To clean up the transaction, the coordinating node may modify the state of the transaction record for the write transaction from staging to committed. In some cases, the coordinating node may resolve the write intents of the write transaction to MVCC (e.g., committed) values by removing the pointer to the transaction record. Based on removing the pointer to the transaction record for the write transaction, the coordinating node may delete the write intents of the transaction. Based on the deletion of each of the write intents for the transaction, the transaction record may be deleted. Additional features for a commit protocol are described at least in U.S. patent application Ser. No. 18/316,851, which is hereby incorporated by reference herein in its entirety.

In some embodiments, the transaction layer may track timing of transactions (e.g., to maintain serializability). The transaction layer may implement hybrid-logical clocks (HLCs) to track time within the cluster. An HLC may be composed of a physical component (e.g., which may be close to local actual time) and a logical component (e.g., which is used to distinguish between events with the same physical component). HLC time may always be greater than or be equal to the actual time. Each node may include a local HLC.

For a transaction, the gateway node (e.g., the node that initially receives a transaction) may determine a timestamp for the transaction and included requests based on HLC time for the node. The transaction layer may enable transaction timestamps based on HLC time. A timestamp within the cluster may be used to track versions of KVs (e.g., through MVCC as to be described herein) and provide guaranteed transactional isolation. A timestamp for a write intent as described herein may be equivalent to the assigned timestamp of a transaction corresponding to the write intent when the write intent was written to storage. A timestamp for a write intent corresponding to a transaction may be less than or equal to a commit timestamp for a transaction. When a timestamp for a write intent is less than a commit timestamp for the transaction that wrote the write intent (e.g., based on advancing the commit timestamp due to a transaction conflict or a most-recent timestamp indicated by a timestamp cache), during asynchronous intent resolution, the committed, MVCC version of the write intent may have its respective timestamp advanced to be equivalent to the commit timestamp of the transaction.

For a transaction, based on a node sending a request for the transaction to another node, the node may include the timestamp generated by the local HLC (e.g., the HLC of the node) with the transaction. Based on receiving a request from another node (e.g., sender node), a node (e.g., receiver node) may inform the local HLC of the timestamp supplied with the transaction by the sender node. In some cases, the receiver node may update the local HLC of the receiver node with the timestamp included in the received transaction. Such a process may ensure that all data read and/or written to a node has a timestamp less than the HLC time at the node. Accordingly, the leaseholder for a range may serve reads for data stored by the leaseholder, where the read transaction that reads the data includes an HLC timestamp greater than HLC timestamp of the MVCC value read by the read transaction (e.g., such that the read occurs after the write).

To provide serializability within the cluster, based on a transaction reading a value of a range, the transaction layer may store the transaction operation's timestamp in a timestamp cache stored at the leaseholder replica of the range. For each read operation directed to a range, the timestamp cache may record and include an indication of the latest timestamp (e.g., the timestamp that is the furthest ahead in time) at which value(s) of the range that were read by a read operation of a transaction. Based on execution of a write transaction, the transaction layer may compare the timestamp of the write transaction to the latest timestamp indicated by the timestamp cache. If the timestamp of the write transaction is less than the latest timestamp indicated by the timestamp cache, the transaction layer may attempt to advance the timestamp of the write transaction forward to a later timestamp. In some cases, advancing the timestamp may cause the write transaction to restart in the second phase of the transaction as to be described herein with respect to read refreshing.

As described herein, the SQL layer may convert SQL statements (e.g., received from client devices) to KV operations. KV operations generated from the SQL layer may use a Client Transaction (CT) transactional interface of the transaction layer to interact with the KVs stored by the cluster. The CT transactional interface may include a transaction coordinator. The transaction coordinator may perform one or more operations as a part of the transaction layer. Based on the execution of a transaction, the transaction coordinator may send (e.g., periodically send) “heartbeat” messages to a transaction record for the transaction. These messages may indicate that the transaction should keep executing (e.g., be kept alive). If the transaction coordinator fails to send the “heartbeat” messages, the transaction layer may modify the transaction record for the transaction to an aborted status. The transaction coordinator may track each written KV and/or KV range during the course of a transaction. In some embodiments, the transaction coordinator may clean and/or otherwise clear accumulated transaction operations. The transaction coordinator may clear an accumulated write intent for a write transaction based on the status of the transaction changing to committed or aborted.

As described herein, to track the status of a transaction during execution, the transaction layer writes to a transaction record corresponding to the transaction. Write intents of the transaction may route conflicting transactions to the transaction record based on the pointer to the transaction record included in the write intents, such that the conflicting transaction may determine a status for conflicting write intents as indicated in the transaction record. The transaction layer may write a transaction record to the same range as the first key subject to a transaction. The transaction coordinator may track the first key subject to a transaction. In some cases, the transaction layer may generate the transaction record when one of the following occurs: the write request commits; the transaction coordinator sends heartbeat messages for the transaction; or an operation forces the transaction to abort. As described herein, a transaction record may have one of the following states: pending, committed, staging, or aborted. In some cases, the transaction record may not exist. If a transaction encounters a write intent where a transaction record corresponding to the write intent does not exist, the transaction may use the timestamp of the write intent to determine how to proceed with respect to the observed write intent. If the timestamp of the write intent is within a transaction liveness threshold, the write intent may be treated as pending. If the timestamp of the write intent is not within the transaction liveness threshold, the write intent may be treated as aborted. A transaction liveness threshold may be a duration configured based on a time period for sending “heartbeat” messages. For example, the transaction liveness threshold may be a duration lasting for five “heartbeat” message time periods, such that after five missed heartbeat messages, a transaction may be aborted. The transaction record for a committed transaction may remain until each of the write intents of the transaction are converted to committed MVCC values stored on persistent storage of a node.

As described herein, in the transaction layer, values may not be written directly to the storage layer as committed MVCC values during a write transaction. Values may be written in a provisional (e.g., uncommitted) state referred to as a write intent. Write intents may be MVCC values including a pointer to a transaction record to which the MVCC value belongs. Based on interacting with a write intent (instead of a committed MVCC value), an operation may determine the status of the transaction record, such that the operation may determine how to interpret the write intent. As described herein, if a transaction record is not found for a write intent, the operation may determine the timestamp of the write intent to evaluate whether or not the write intent may be considered to be expired.

In some embodiments, the transaction layer may include a concurrency manager for concurrency control. The concurrency manager may sequence incoming requests (e.g., from transactions) and may provide isolation between the transactions that issued those requests that intend to perform conflicting operations. This activity may be referred to as concurrency control. The concurrency manager may combine the operations of a latch manager and a lock table to accomplish this work. The latch manager may sequence the incoming requests and may provide isolation between those requests. The lock table may provide locking and sequencing of requests (in combination with the latch manager). The lock table may be a per-node, in-memory (e.g., stored by volatile, non-persistent storage) data structure. The lock table may hold a collection of locks acquired by transactions that are in-progress as to be described herein.

As described herein, the concurrency manager may be a structure that sequences incoming requests and provides isolation between the transactions that issued those requests, where the requests intend to perform conflicting operations. During sequencing, the concurrency manager may identify conflicts. The concurrency manager may resolve conflicts based on passive queuing and/or active pushing. Once a request has been sequenced by the concurrency manager, the request may execute (e.g., without other conflicting requests/operations) based on the isolation provided by the concurrency manager. This isolation may last for the duration of the request. The isolation may terminate based on (e.g., after) completion of the request. Each request in a transaction may be isolated from other requests. Each request may be isolated during the duration of the request, after the request has completed (e.g., based on the request acquiring locks), and/or within the duration of the transaction comprising the request. The concurrency manager may allow transactional requests (e.g., requests originating from transactions) to acquire locks, where the locks may exist for durations longer than the duration of the requests themselves. The locks may extend the duration of the isolation provided over specific keys stored by the cluster to the duration of the transaction. The locks may be released when the transaction commits or aborts. Other requests that encounter and/or otherwise interact with the locks (e.g., while being sequenced) may wait in a queue for the locks to be released. Based on the locks being released, the other requests may proceed to execute. The concurrency manager may include information for external locks (e.g., the write intents).

In some embodiments, one or more locks may not be controlled by the concurrency manager, such that one or more locks may not be discovered during sequencing. As an example, write intents (e.g., replicated, exclusive locks) may be stored such that that may not be detected until request evaluation time. In most embodiments, fairness may be ensured between requests, such that if any two requests conflict, the request that arrived first will be sequenced first. Sequencing may guarantee first-in, first-out (FIFO) semantics. An exception to FIFO semantics is that a request that is part of a transaction which has already acquired a lock may not need to wait on that lock during sequencing. The request may disregard any queue that has formed on the lock. Lock tables as to be described herein may include one or more other exceptions to the FIFO semantics described herein.

In some embodiments, as described herein, a lock table may be a per-node, in-memory data structure. The lock table may store a collection of locks acquired by in-progress transactions. Each lock in the lock table may have an associated lock wait-queue. Conflicting transactions can queue in the associated lock wait-queue based on waiting for the lock to be released. Items in the locally stored lock wait-queue may be propagated as necessary (e.g., via RPC) to an existing Transaction Wait Queue (TWQ). The TWQ may be stored on the leader replica of the range, where the leader replica on which the first write request of a transaction occurred may contain the transaction record.

As described herein, databases stored by the cluster may be read and written using one or more “requests”. A transaction may be composed of one or more requests, such as read requests and write requests. A read request may be a request to read data stored by a range, such as a value of a particular key at a timestamp corresponding to the request. A write request may be a request to write (e.g., update or modify) data stored by a range, such that the write request writes to the most recent value of a key included in the range. Isolation may be needed to separate requests. Additionally, isolation may be needed to separate transactions. Isolation for requests and/or transactions may be accomplished by maintaining multiple versions and/or by allowing requests to acquire locks. Isolation based on multiple versions may require a form of mutual exclusion, such that a read and a conflicting lock acquisition do not occur concurrently. The lock table may provide locking and/or sequencing of requests (in combination with the use of latches).

In some embodiments, locks may last for a longer duration than the requests associated with the locks. Locks may extend the duration of the isolation provided over specific KVs to the duration of the transaction associated with the lock. As described herein, locks may be released when the transaction commits or aborts. Other requests that encounter and/or otherwise interact with the locks (e.g., while being sequenced) may wait in a queue for the locks to be released. Based on the locks being released, the other requests may proceed. In some embodiments, the lock table may enable fairness between requests, such that if two requests conflict, then the request that arrived first may be sequenced first. In some cases, there may be exceptions to the FIFO semantics as described herein. A request that is part of a transaction that has acquired a lock may not need to wait on that lock during sequencing, such that the request may ignore a queue that has formed on the lock. In some embodiments, contending requests that encounter different levels of contention may be sequenced in a non-FIFO order. Such sequencing in a non-FIFO order may enable greater concurrency. As an example, if requests R₁ and R₂ contend on key K₂, but R₁ is also waiting at key K₁, R₂ may be determined to have priority over R₁, such that R₂ may be executed on K₂.

In some embodiments, as described herein, a latch manager may sequence incoming requests and may provide isolation between those requests. The latch manager may sequence and provide isolation to requests under the supervision of the concurrency manager. A latch manager may operate as follows. As write requests occur for a range, a leaseholder of the range may serialize write requests for the range. Serializing the requests may group the requests into a consistent order. To enforce the serialization, the leaseholder may create a “latch” for the keys in the write value, such that a write request may be given uncontested access to the keys. If other requests access the leaseholder for the same set of keys as the previous write request, the other requests may wait for the latch to be released before proceeding. In some cases, read requests may generate latches. Multiple read latches over the same keys may be held concurrently. A read latch and a write latch over the same keys may not be held concurrently.

In some embodiments, the transaction layer may execute transactions at a serializable transaction isolation level. A serializable isolation level may not prevent anomalies in data stored by the cluster. A serializable isolation level may be enforced by requiring the client device to retry transactions if serializability violations are possible.

In some embodiments, the transaction layer may allow for one or more transaction conflict types, where a conflict type may result from a transaction encountering and/or otherwise interacting with a write intent at a key (e.g., at least one key). A write/write transaction conflict may occur when two pending transactions create write intents for the same key. A write/read transaction conflict may occur when a read transaction encounters an existing write intent with a timestamp less than or equal to the timestamp of the read transaction. To resolve the transaction conflict, the transaction layer may proceed through one or more operations. Based on a transaction within the transaction conflict having a defined transaction priority (e.g., high priority, low priority, etc.), the transaction layer may abort the transaction with lower priority (e.g., in a write/write conflict) or advance the timestamp of the transaction having a lower priority (e.g., in a write/read conflict). Based on a transaction within the conflicting transactions being expired, the expired transaction may be aborted. A transaction may be considered to be expired if the transaction does not have a transaction record or the timestamp for the transaction is outside of the transaction liveness threshold. A transaction may be considered to be expired if the transaction record corresponding to the transaction has not received a “heartbeat” message from the transaction coordinator within the transaction liveness threshold. A transaction (e.g., a low priority transaction) that is required to wait on a conflicting transaction may enter the TWQ as described herein.

In some embodiments, the transaction layer may allow for one or more additional conflict types that do not involve write intents. A write after read conflict may occur when a write transaction having a lower timestamp conflicts with a read transaction having a higher timestamp. The timestamp of the write transaction may advance past the timestamp of the read transaction, such that the write transaction may execute. A read within an uncertainty window may occur when a read transaction encounters a KV with a higher timestamp and there exists ambiguity whether the KV should be considered to be in the future or in the past of the read transaction. An uncertainty window may be configured based on the maximum allowed offset between the clocks (e.g., HLCs) of any two nodes within the cluster. In an example, the uncertainty window may be equivalent to the maximum allowed offset. A read within an uncertainty window may occur based on clock skew. The transaction layer may advance the timestamp of the read transaction past the timestamp of the KV according to read refreshing as to be described herein. If the read transaction associated with a read within an uncertainty window has to be restarted, the read transaction may never encounter an uncertainty window on any node which was previously visited by the read transaction. In some cases, there may not exist an uncertainty window for KVs read from the gateway node of the read transaction.

In some embodiments, as described herein, the TWQ may track all transactions that could not advance another blocking, ongoing transaction that wrote write intents observed by the tracked transactions. The transactions tracked by the TWQ may be queued and may wait for the blocking transaction to complete before the transaction can proceed to execute. The structure of the TWQ may map a blocking transaction to the one or more other transactions that are blocked by the blocking transaction via the respective unique IDs corresponding to each of the transactions. The TWQ may operate on the leader replica of a range, where the leader replica includes the transaction record based on being subject to the first write operation included in the blocking, ongoing transaction. Based on a blocking transaction resolving (e.g., by committing or aborting), an indication may be sent to the TWQ that indicates the queued transactions blocked by the blocking transaction may begin to execute. A blocked transaction (e.g., a transaction blocked by a blocking transaction) may examine their transaction status to determine whether they are active. If the transaction status for the blocked transaction indicates the blocked transaction is aborted, the blocked transaction may be removed by the transaction layer. In some cases, deadlock may occur between transactions, where a first transaction may be blocked by second write intents of a second transaction and the second transaction may be blocked by first write intents of the first transaction. If transactions are deadlocked (e.g., blocked on write intents of another transaction), one transaction of the deadlocked transactions may randomly abort, such that the active (e.g., alive) transaction may execute and the deadlock may be removed. A deadlock detection mechanism may identify whether transactions are deadlocked and may cause one of the deadlocked transactions to abort.

In some embodiments, the transaction layer may enable read refreshing. When a timestamp of a transaction has been advanced to a later timestamp, additional considerations may be required before the transaction may commit at the advanced timestamp. The considerations may include checking KVs previously read by the transaction to verify that other write transactions have not occurred at the KVs between the original transaction timestamp and the advanced transaction timestamp. This consideration may prevent serializability violations. The check may be executed by tracking each read using a Refresh Request (RR). If the check succeeds (e.g., write transactions have not occurred between the original transaction timestamp and the advanced transaction timestamp), the transaction may be allowed to commit at the advanced timestamp. A transaction may perform the check at a commit time if the transaction was advanced by a different transaction or by the timestamp cache. A transaction may perform the check based on encountering a read within an uncertainty interval. If the check is unsuccessful, then the transaction may be retried at the advanced timestamp.

In some embodiments, the transaction layer may enable transaction pipelining. Write transactions may be pipelined when being replicated to follower replicas and when being written to storage. Transaction pipelining may reduce the latency of transactions that perform multiple writes. In transaction pipelining, write intents may be replicated from leaseholders (e.g., combined leaseholder and leader replicas) to follower replicas in parallel, such that waiting for a commit occurs at transaction commit time. Transaction pipelining may include one or more operations. In transaction pipelining, for each received statement (e.g., operation) of a transaction, the gateway node corresponding to the transaction may communicate with the leaseholders (L₁, L₂, L₃, . . . , Lᵢ) for the range(s) indicated by the transaction. Each leaseholder Lᵢ may receive the communication from the gateway node and may perform one or more operations in parallel. Each leaseholder Lᵢ may (i) create write intents, and (ii) send the write intents to corresponding follower nodes for the leaseholder Lᵢ. After sending the write intents to the corresponding follower nodes, each leaseholder Lᵢ may send an indication to the gateway node that the write intents have been sent. Replication of the intents may be referred to as “in-flight” once the leaseholder Lᵢ sends the write intents to the follower replicas. Before committing the transaction (e.g., by updating the transaction record for the transaction via a transaction coordinator), the gateway node may wait for the write intents to be replicated in parallel to each of the follower nodes of the leaseholders. Based on receiving responses from the leaseholders that the write intents have propagated to the follower nodes, the gateway node may commit the transaction by causing an update to the status of the transaction record of the transaction. Additional features of distributed consensus (e.g., Raft) operations are described with respect to “Transaction Execution”.

### Storage Layer

In some embodiments, the database architecture for databases stored by a cluster (e.g., cluster 102) of database nodes may include a storage layer. The storage layer may enable the cluster to read and write data to storage device(s) of each node. As described herein, data may be stored as KV pairs on the storage device(s) using a storage engine. In some cases, the storage engine may be a Pebble storage engine. The storage layer may serve successful read transactions and write transactions from the replication layer.

In some embodiments, each node of the cluster may include at least one store, which may be specified when a node is activated and/or otherwise added to a cluster. Read transactions and write transactions may be processed from the store. Each store may contain two instances of the storage engine as described herein. A first instance of the storage engine may store temporary distributed SQL data. A second instance of the storage engine may store data other than the temporary distributed SQL data, including system data (e.g., meta ranges) and user data (e.g., table data, client data, etc.). For each node, a block cache may be shared between each store of the node. The store(s) of a node may store a collection of replicas of a range as described herein, where a particular replica may not be replicated among stores of the same node (or the same node), such that a replica may only exist once at a node.

In some embodiments, as described herein, the storage layer may use an embedded KV data store (e.g., Pebble). The KV data store may be used with an application programming interface (API) to read and write data to storage devices (e.g., persistent storage devices) of nodes of the cluster. The KV data store may enable atomic write batches and snapshots.

In some embodiments, the storage layer may use MVCC to enable concurrent requests. In some cases, the use of MVCC by the storage layer may guarantee consistency for the cluster. As described herein, HLC timestamps may be used to differentiate between different versions of data by tracking commit timestamps for data. HLC timestamps may be used to identify a garbage collection expiration for a value as to be described herein. In some cases, the storage layer may support time travel queries (e.g., queries directed to MVCC versions of keys at previous timestamps). Time travel queries may be enabled by MVCC versions of keys.

In some embodiments, the storage layer may aggregate MVCC values (e.g., garbage collect MVCC values) to reduce the storage size of the data stored by the storage (e.g., the disk) of nodes. The storage layer may compact MVCC values (e.g., old MVCC values) based on the existence of a newer MVCC value with a timestamp that is older than a garbage collection period. A garbage collection period may be configured for the cluster, database, and/or table. Garbage collection may be executed for MVCC values that are not configured with a protected timestamp. A protected timestamp subsystem may ensure safety for operations that rely on historical data. Operations that may rely on historical data may include imports, backups, streaming data using change feeds, and/or online schema changes. Protected timestamps may operate based on generation of protection records by the storage layer. Protection records may be stored in an internal system table. In an example, a long-running job (e.g., such as a backup) may protect data at a certain timestamp from being garbage collected by generating a protection record associated with that data and timestamp. Based on successful creation of a protection record, the MVCC values for the specified data at timestamps less than or equal to the protected timestamp may not be garbage collected. When the job (e.g., the backup) that generated the protection record is complete, the job may remove the protection record from the data. Based on removal of the protection record, the garbage collector may operate on the formerly protected data.

In some embodiments, the storage layer may use a log-structured merge (LSM) tree at each node of the cluster to manage data storage. In some cases, other types of data storage structures, such as a B-tree, may be used in addition or in place of an LSM tree at each node. In some cases, the LSM tree is a hierarchical tree including a number of levels. For each level of the LSM tree, one or more files may be stored on persistent storage media (e.g., disk storage, solid state drive (SSD) storage, etc.) that include the data referenced at that respective level. The files may be sorted string table files as described herein. In some cases, sstables are an on-disk (e.g., on persistent, non-volatile storage such as disk storage, SSD storage, etc.) representation of sorted lists of KV pairs. Sstables can be immutable, such that they are never modified (e.g., even during a compaction process) and instead are deleted and written.

### Database Architecture

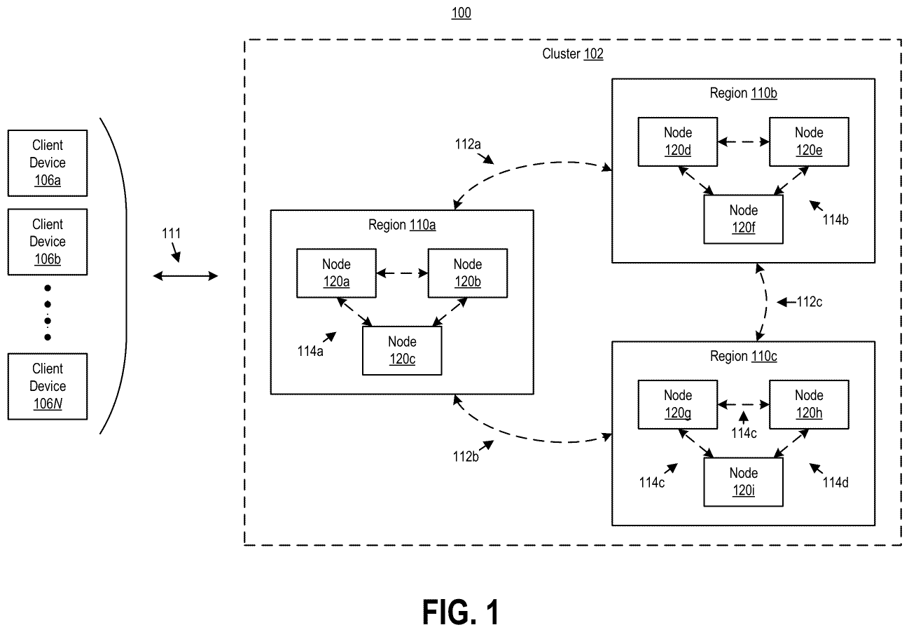

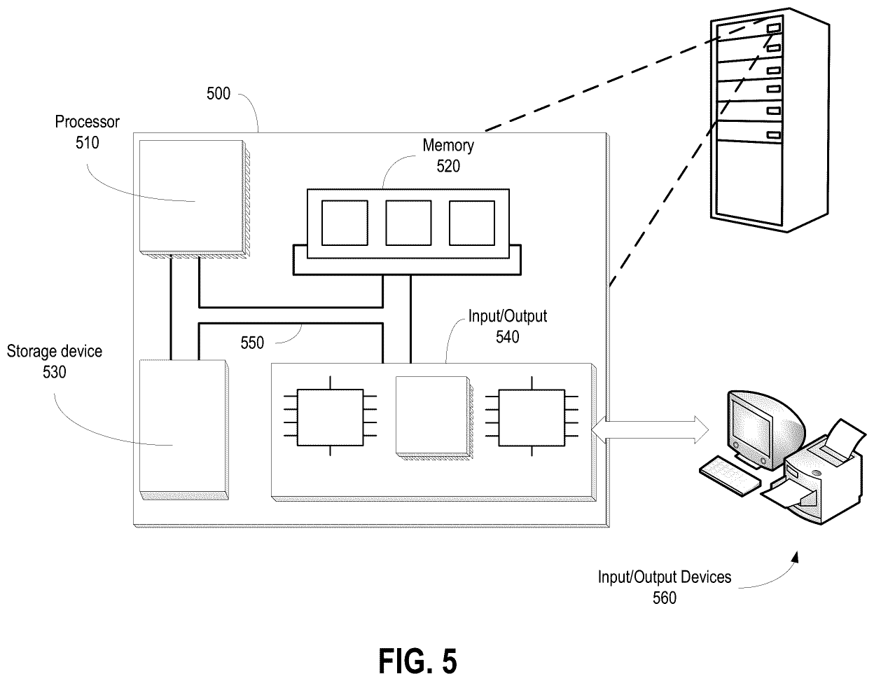

Referring to FIG. 1, an illustrative distributed computing system 100 is presented. The computing system 100 may include a cluster 102. In some cases, the computing system may include one or more additional clusters 102. The cluster 102 may include one or more nodes 120 distributed among one or more geographic regions 110. The geographic regions may correspond to cluster regions and database regions as described further below. A node 120 may be a computing device (e.g., a server computing device). In some cases, a node 120 may include at least portions of the computing system as described herein with respect to FIG. 5. As an example, a node 120 may be a server computing device. A region 110 may correspond to a particular building (e.g., a data center), city, state/province, country, geographic region, and/or a subset of any one of the above. A region 110 may include multiple elements, such as a country and a geographic identifier for the country. For example, a region 110 may be indicated by Country=United States and Region=Central, which may indicate a region 110 as the Central United States. As shown in FIG. 1, the cluster 102 may include regions 110a, 110b, and 110c. In some cases, the cluster 102 may include one region 110. In an example, the region 110a may be the Eastern United States, the region 110b may be the Central United States, and the region 110c may be the Western United States. Each region 110 of the cluster 102 may include one or more nodes 120. In some cases, a region 110 may not include any nodes 120. The region 110a may include nodes 120a, 120b, and 120c. The region 110b may include the nodes 120d, 120e, and 120f. The region 110c may include nodes 120g, 120h, and 120i.

Each node 120 of the cluster 102 may be communicatively coupled via one or more networks 112 and 114. In some cases, the cluster 102 may include networks 112a, 112b, and 112c, as well as networks 114a, 114b, 114c, and 114d. The networks 112 may include a local area network (LAN), wide area network (WAN), and/or any other suitable network. In some cases, the one or more networks 112 may connect nodes 120 of different regions 110. The nodes 120 of region 110a may be connected to the nodes 120 of region 110b via a network 112a. The nodes 120 of region 110a may be connected to the nodes 120 of region 110c via a network 112b. The nodes 120 of region 110b may be connected to the nodes 120 of region 110c via a network 112c. The networks 114 may include a LAN, WAN, and/or any other suitable network. In some cases, the networks 114 may connect nodes 120 within a region 110. The nodes 120a, 120b, and 120c of the region 110a may be interconnected via a network 114a. The nodes 120d, 120c, and 120f of the region 110b may be interconnected via a network 114b. In some cases, the nodes 120 within a region 110 may be connected via one or more different networks 114. The node 120g of the region 110c may be connected to nodes 120h and 120i via a network 114c, while nodes 120h and 120i may be connected via a network 114d. In some cases, the nodes 120 of a region 110 may be located in different geographic locations within the region 110. For example, if region 110a is the Eastern United States, nodes 120a and 120b may be located in New York, while node 120c may be located in Massachusetts.

In some embodiments, the computing system 100 may include one or more client devices 106. The one or more client devices 106 may include one or more computing devices. In some cases, the one or more client devices 106 may each include at least portions of the computing system as described herein with respect to FIG. 5. In an example, the one or more client devices 106 may include laptop computing devices, desktop computing devices, mobile computing devices, tablet computing devices, and/or server computing device. As shown in FIG. 1, the computing system 100 may include client devices 106a, 106b, and one or more client devices 106 up to client device 106N, where N is any suitable number of client devices 106 included in the computing system 100. The client devices 106 may be communicatively coupled to the cluster 102, such that the client devices 106 may access and/or otherwise communicate with the nodes 120. One or more networks 111 may couple the client devices 106 the nodes 120. The one or more networks 111 may include a LAN, a WAN, and/or any other suitable network as described herein. As an example, the client devices 106 may communicate with the nodes 120 via a SQL client operating at each respective client device 106. To access and/or otherwise interact with the data stored by the cluster 102, a client device 106 may communicate with a gateway node, which may be a node 120 of the cluster that is closest (e.g., by latency, geographic proximity, and/or any other suitable indication of closeness) to the client device 106. The gateway node may route communications between a client device 106 and any other node 120 of the cluster.

### Transaction Execution

In some embodiments, as described herein, distributed transactional databases stored by the cluster (e.g., cluster 102) of database nodes may enable one or more transactions. Each transaction may include one or more requests (e.g., queries) directed to performing one or more operations. The one or more requests may include read request and/or write requests. In some cases, a request may be a query (e.g., a SQL query). A request may traverse one or more nodes of a cluster to execute the request. A request may interact with (e.g., sequentially interact with) one or more of the following: a SQL client, a load balancer, a gateway, a leaseholder, and/or a Raft leader as described herein. A SQL client may send a request (e.g., query) to a cluster. The request may be included in a transaction, where the transaction is a read and/or a write transaction as described herein. A load balancer may route the request from the SQL client to the nodes of the cluster. A gateway node may be a node that initially receives the request and/or sends a response to the SQL client. A leaseholder may be a node that serves reads and coordinates writes for a range of keys (e.g., keys indicated in the request) as described herein. A Raft leader may be a node that maintains consensus among the replicas for a range via coordinate of a consensus protocol.

A SQL client (e.g., operating at a client device 106a) may send a request (e.g., a SQL request) to a cluster (e.g., cluster 102). The request may be sent over a network (e.g., the network 111). A load balancer may determine a node of the cluster to which to send the request. The node may be a node of the cluster having the lowest latency and/or having the closest geographic location to the computing device on which the SQL client is operating. A gateway node (e.g., node 120a) may receive the request from the load balancer. The gateway node may parse the request to determine whether the request is valid. The request may be valid based on conforming to the syntax (e.g., SQL syntax) of the database(s) stored by the cluster. An optimizer operating at the gateway node may generate a number of logically equivalent query plans based on the received request. Each query plan may correspond to a physical operation tree configured to be executed for the query. The optimizer may select an optimal query plan from the number of query plans (e.g., based on a cost model). Based on the completion of request planning, a query execution engine may execute the selected, optimal query plan using a transaction coordinator as described herein. A transaction coordinator operating on a gateway node may perform one or more operations as a part of the transaction layer. The transaction coordinator may perform KV operations on a database stored by the cluster. The transaction coordinator may account for keys indicated and/or otherwise involved in a transaction. The transaction coordinator may package KV operations into a Batch Request as described herein, where the Batch Request may be forwarded on to a Distribution Sender (DistSender) operating on the gateway node.

A DistSender of a gateway node and/or coordinating node may receive Batch Requests from a transaction coordinator of the same node. The DistSender of the gateway node may receive the Batch Request from the transaction coordinator. The DistSender may determine the operations indicated by the Batch Request and may determine the node(s) (e.g., the leaseholder node(s)) that should receive requests corresponding to the operations for the range. The DistSender may generate one or more Batch Requests based on determining the operations and the node(s) as described herein. The DistSender may send a first Batch Request for each range in parallel. Based on receiving a provisional acknowledgment from a leaseholder node's evaluator, the DistSender may send the next Batch Request for the range corresponding to the provisional acknowledgement. The DistSender may wait to receive acknowledgments for write operations and values for read operations corresponding to the sent Batch Requests.

As described herein, the DistSender of the gateway node may send Batch Requests to leaseholders (or other replicas) for data indicated by the Batch Request. In some cases, the DistSender may send Batch Requests to nodes that are not the leaseholder for the range (e.g., based on out of date leaseholder information). Nodes may or may not store the replica indicated by the Batch Request. Nodes may respond to a Batch Request with one or more responses. A response may indicate the node is no longer a leaseholder for the range. The response may indicate the last known address of the leaseholder for the range. A response may indicate the node does not include a replica for the range. A response may indicate the Batch Request was successful if the node that received the Batch Request is the leaseholder. The leaseholder may process the Batch Request. As a part of processing of the Batch Request, each write operation in the Batch Request may compare a timestamp of the write operation to the timestamp cache. A timestamp cache may track the highest timestamp (e.g., most recent timestamp) for any read operation that a given range has served. The comparison may ensure that the write operation has a higher timestamp than any timestamp indicated by the timestamp cache. If a write operation has a lower timestamp than any timestamp indicated by the timestamp cache, the write operation may be restarted at an advanced timestamp that is greater than the value of the most recent timestamp indicated by the timestamp cache.

In some embodiments, operations indicated in the Batch Request may be serialized by a latch manager of a leaseholder. For serialization, each write operation may be given a latch on a row. Any read and/or write operations that arrive after the latch has been granted on the row may be required to wait for the write operation to complete. Based on completion of the write operation, the latch may be released and the subsequent operations can proceed to execute. In some cases, a batch evaluator may ensure that write operations are valid. The batch evaluator may determine whether the write operation is valid based on the leaseholder's data. The leaseholder's data may be evaluated by the batch evaluator based on the leaseholder coordinating write operations to the range. If the batch evaluator determines the write operation to be valid, the leaseholder may send a provisional acknowledgement to the DistSender of the gateway node, such that the DistSender may begin to send subsequent Batch Requests for the range to the leaseholder.

In some embodiments, operations may read from the local instance of the storage engine as described herein to determine whether write intents are present at a key. If write intents are present at a particular key, an operation may resolve write intents as described herein. If the operation is a read operation and write intents are not present at the key, the read operation may read the value at the key of the leaseholder's storage engine. Read responses corresponding to a transaction may be aggregated into a Batch Response by the leaseholder. The Batch Response may be sent to the DistSender of the gateway node. If the operation is a write operation and write intents are not present at the key, the KV operations included in the Batch Request that correspond to the write operation may be converted to distributed consensus (e.g., Raft) operations and write intents, such that the write operation may be replicated to the replicas of the range.

With respect to a single round of distributed consensus, the leaseholder may propose the Raft operations to the leader replica of the Raft group (e.g., where the leader replica is typically also the leaseholder). Based on receiving the Raft operations, the leader replica may send the Raft operations to the follower replicas of the Raft group. Writing and/or execution of Raft operations as described herein may include writing one or more write intents to persistent storage. The leader replica and the follower replicas may attempt to write the Raft operations to their respective Raft logs. When a particular replica writes the Raft operations to its respective local Raft log, the replica may acknowledge success of the Raft operations by sending an indication of a success of writing the Raft operations to the leader replica. If a threshold number of the replicas acknowledge writing the Raft operations (e.g., the write operations) to their respective Raft log, consensus may be achieved such that the Raft operations may be committed (referred to as “consensus-committed” or “consensus-commit”). The consensus-commit may be achieved for a particular Raft operation when a majority of the replicas (e.g., including or not including the leader replica) have written the Raft operation to their local Raft log. The consensus-commit may be discovered or otherwise known to the leader replica to be committed when a majority of the replicas have sent an indication of success for the Raft operation to the leader replica. Based on a Raft operation (e.g., write operation) being consensus-committed among a Raft group, each replica included in the Raft group may apply the committed entry to their respective local state machine. Based on achieving consensus-commit among the Raft group, the Raft operations (e.g., write operations included in the write transaction) may be considered to be committed (e.g., implicitly committed as described herein). The gateway node may update the status of the transaction record for the transaction corresponding to the Raft operations to committed (e.g., explicitly committed as described herein). A latency for the above-described distributed consensus round may be equivalent to a duration for sending a Raft operation from the leader replica to the follower replicas, receiving success responses for the Raft operation at the leader replica from at least some of the follower replicas (e.g., such that a majority of replicas write to their respective Raft log), and writing a write intent to persistent storage at the leader and follower replicas in parallel.

In some embodiments, based on the leader replica writing the Raft operations to the Raft log and receiving an indication of the consensus-commit among the Raft group, the leader replica may send a commit acknowledgement to the DistSender of the gateway node. The DistSender of the gateway node may aggregate commit acknowledgements from each write operation included in the Batch Request. In some cases, the DistSender of the gateway node may aggregate read values for each read operation included in the Batch Request. Based on completion of the operations of the Batch Request, the DistSender may record the success of each transaction in a corresponding transaction record. To record the success of a transaction, the DistSender may check the timestamp cache of the range where the first operation of the write transaction occurred to determine whether the timestamp for the write transaction was advanced. If the timestamp was advanced, the transaction may perform a read refresh to determine whether values associated with the transaction had changed. If the read refresh is successful (e.g., no values associated with the transaction had changed), the transaction may commit at the advanced timestamp. If the read refresh fails (e.g., at least some value associated with the transaction had changed), the transaction may be restarted. Based on determining the read refresh was successful and/or that the timestamp was not advanced for a write transaction, the DistSender may change the status of the corresponding transaction record to committed as described herein. The DistSender may send values (e.g., read values) to the transaction coordinator. The transaction coordinator may send the values to the SQL layer. In some cases, the transaction coordinator may also send a request to the DistSender, where the request includes an indication for the DistSender to convert write intents to committed values (e.g., MVCC values). The SQL layer may send the values as described herein to the SQL client that initiated the query (e.g., operating on a client device).

### Read Transaction Execution

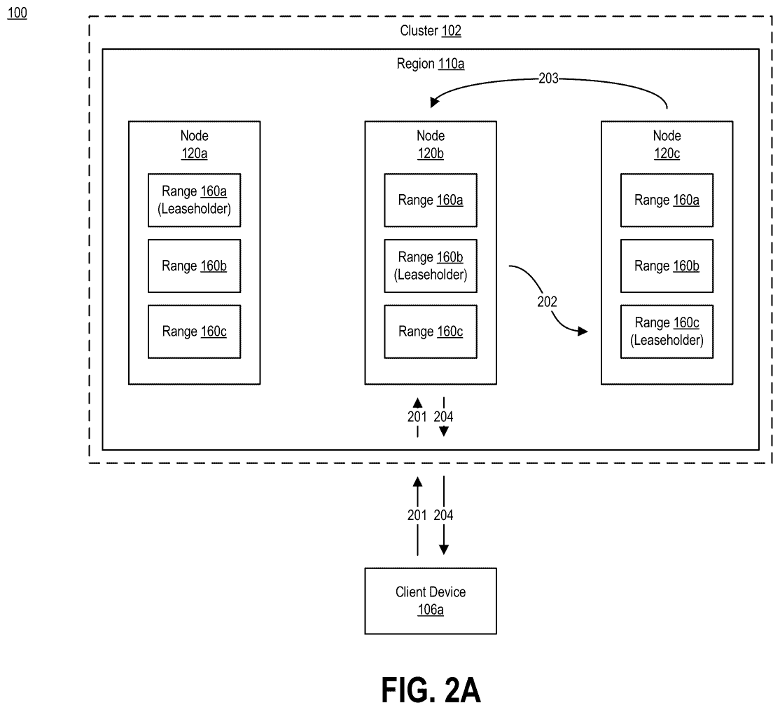

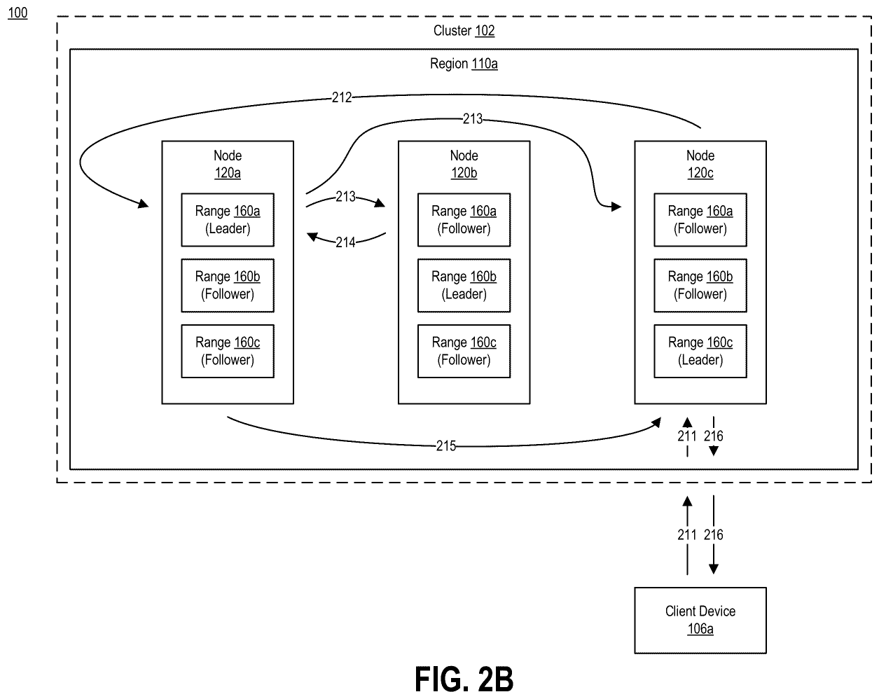

Referring to FIG. 2A, an example of execution of a read transaction including at least one read request at the computing system 100 is presented. In some cases, the nodes 120a, 120b, and 120c, of region 110a may include one or more replicas of ranges 160. The node 120a may include replicas of ranges 160a, 160b, and 160c, where ranges 160a, 160b, and 160c are different ranges. The node 120a may include the leaseholder replica for range 160a (as indicated by “Leaseholder” in FIG. 2A). The node 120b may include replicas of ranges 160a, 160b, and 160c. The node 120b may include the leaseholder replica for range 160b (as indicated by “Leaseholder” in FIG. 2A). The node 120c may include replicas of ranges 160a, 160b, and 160c. The node 120c may include the leaseholder replica for range 160c (as indicated by “Leaseholder” in FIG. 2A). While FIG. 2A is described with respect to communication between nodes 120 of a single region (e.g., region 110a), a read transaction may operate similarly between nodes 120 located within different geographic regions.

In some embodiments, a client device 106 may initiate a read transaction at a node 120 of the cluster 102. Based on the KVs indicated by the read transaction, the node 120 that initially receives the read transaction (e.g., the gateway node) from the client device 106 may route the read transaction to a leaseholder of the range 160 comprising the KVs indicated by the read transaction. The leaseholder of the range 160 may serve the read transaction and send the read data to the gateway node. The gateway node may send the read data to the client device 106.

As shown in FIG. 2A, at step 201, the client device 106 may send a read transaction to the cluster 102. The read transaction may be received by node 120b as the gateway node. The node 120b may be a node 120 located closest to the client device 106, where the closeness between the nodes 120 and a client device 106 may correspond to a latency and/or a proximity as described herein. The read transaction may be directed to data stored by the range 160c. At step 202, the node 120b may route the received read transaction to node 120c. The read transaction may be routed to node 120c based on the node 120c being the leaseholder of the range 160c. The node 120c may receive the read transaction from node 120b and serve the read transaction from the range 160c. At step 203, the node 120c may send the read data to the node 120b. The node 120c may send the read data to node 120b based on the node 120b being the gateway node for the read transaction. The node 120b may receive the read data from node 120c. At step 204, the node 120b may send the read data to the client device 106a to complete the read transaction. If node 120b had been configured to include the leaseholder for the range 160c, the node 120b may have served the read data to the client device directly after step 201, without routing the read transaction to the node 120c.

### Write Transaction Execution

Referring to FIG. 2B, an example of execution of a write transaction including at least one write request at the computing system 100 is presented. In some cases, as described herein, the nodes 120a, 120b, and 120c, of region 110a may include one or more replicas of ranges 160. The node 120a may include replicas of ranges 160a, 160b, and 160c, where ranges 160a, 160b, and 160c are different ranges. The node 120a may include the leaseholder replica and the leader replica for range 160a (as indicated by “Leaseholder” in FIG. 2A and “Leader” in FIG. 2B). The node 120b may include replicas of ranges 160a, 160b, and 160c. The node 120b may include the leader replica for range 160b (as indicated by “Leader” in FIG. 2B). The node 120c may include replicas of ranges 160a, 160b, and 160c. The node 120c may include the leader replica for range 160c (as indicated by “Leader” in FIG. 2B). While FIG. 2B is described with respect to communication between nodes 120 of a single region (e.g., region 110a), a write transaction may operate similarly between nodes 120 located within different geographic regions.

In some embodiments, a client device 106 may initiate a write transaction at a node 120 of the cluster 102. Based on the KVs indicated by the write transaction, the node 120 that initially receives the write transaction (e.g., the gateway node) from the client device 106 may route the write transaction to a leaseholder of the range 160 comprising the KVs indicated by the write transaction. The leaseholder of the range 160 may route the write request to the leader replica of the range 160. In most cases, the leaseholder of the range 160 and the leader replica of the range 160 are the same. The leader replica may append the write transaction to a Raft log of the leader replica and may send the write transaction to the corresponding follower replicas of the range 160 for replication. Follower replicas of the range may append the write transaction to their corresponding Raft logs and send an indication to the leader replica that the write transaction was appended. Based on a threshold number (e.g., a majority) of the replicas indicating and/or sending an indication to the leader replica that the write transaction was appended, the write transaction may be committed by the leader replica. The leader replica may send an indication to the follower replicas to commit the write transaction. The leader replica may send an acknowledgement of a commit of the write transaction to the gateway node. The gateway node may send the acknowledgement to the client device 106.

As shown in FIG. 2B, at step 211, the client device 106 may send a write transaction to the cluster 102. The write transaction may be received by node 120c as the gateway node. The write transaction may be directed to data stored by the range 160a. At step 212, the node 120c may route the received write transaction to node 120a. The write transaction may be routed to node 120a based on the node 120a being the leaseholder of the range 160a. Based on the node 120a including the leader replica for the range 160a, the leader replica of range 160a may append the write transaction to a Raft log at node 120a. At step 213, the leader replica may simultaneously send the write transaction to the follower replicas of range 160a on the node 120b and the node 120c. The node 120b and the node 120c may append the write transaction to their respective Raft logs. At step 214, the follower replicas of the range 160a (at nodes 120b and 120c) may send an indication to the leader replica of the range 160a that the write transaction was appended to their Raft logs. Based on a threshold number of replicas indicating the write transaction was appended to their Raft logs, the leader replica and follower replicas of the range 160a may commit the write transaction. At step 215, the node 120a may send an acknowledgement of the committed write transaction to the node 120c. At step 216, the node 120c may send the acknowledgement of the committed write transaction to the client device 106a to complete the write transaction.

### Exemplary Method for Write Request Processing for a Consensus Group

In some embodiments, as described herein at least with respect to FIG. 2B, the cluster 102 may receive write requests (e.g., included in write transactions) from client devices 106 directed to writing to data stored in one or more ranges 160. For example, a write request may include instructions to write to the values of a number of keys included in a range 160 and/or add new values to keys included in the range 160. In some cases, the client devices 106 may correspond to more than one tenant, such that different tenants may access and interact with their associated ranges 160 stored by the cluster 102. Accordingly, write requests included in transactions sent to the cluster 102 by a client device 106 may include an indicator of a tenant tⱼ associated with the write requests and an indicator of a range rᵢ the write requests are intended to modify. Similarly, read requests may include an indicator of a tenant tⱼ associated with the read requests and an indicator of a range rᵢ the read requests are intended to read from.

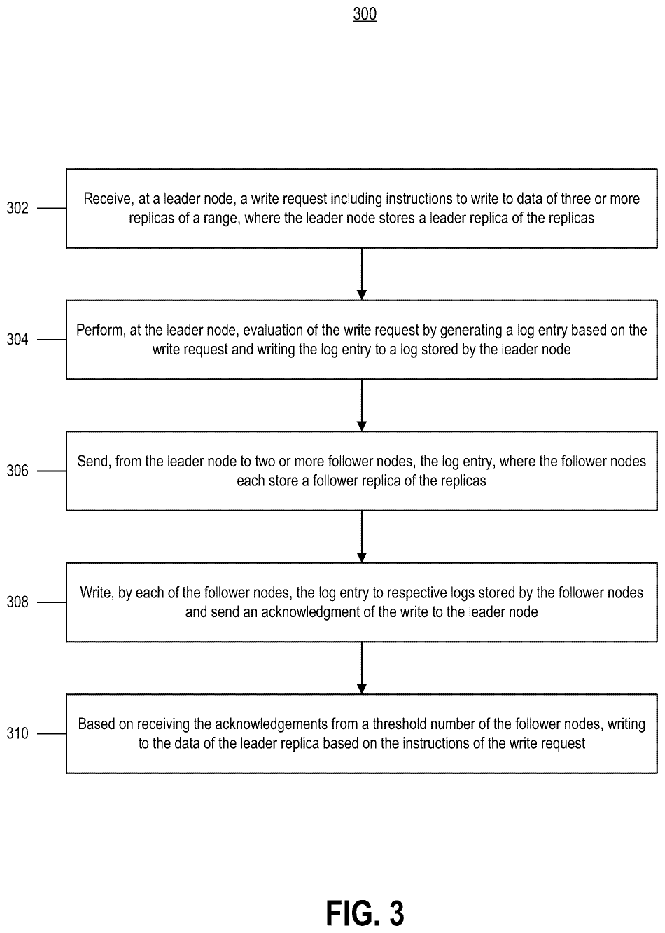

In some embodiments, as described herein, a consensus group for a particular partition (e.g., range) may execute a consensus protocol to execute and commit write requests to the replicas of the range. The consensus group can include the leader replica and the follower replicas of the range, which form the voting replicas of the range. Each range can have a respective consensus group of replicas used to commit write requests including instructions to the replicas of the range. Referring to FIG. 3, an exemplary flowchart of a method 300 for processing a write request using a consensus protocol is illustrated. While the method 300 is described with respect to a single write request including instructions to write to a range replicated among three replicas and having a failure tolerance of one node storing a replica, the method 300 may be executed in parallel by a number of consensus groups for a number of write requests and increased numbers of replicas may be included in a consensus group to provide additional tolerance to node failures. A client device 106 may send the write request to the cluster 102 as a part of a transaction including one or more requests. A gateway node may receive the transaction as described herein and may route the write request to a leaseholder node storing the leaseholder replica for a range to which the write request is directed. In some cases, the leaseholder replica may also be the leader replica for the range.

At step 302, a leader node (e.g., node 120a) storing a leader replica for a range can receive a write request including instructions to write (e.g., modify) to data of three or more replicas of the range, where the leader node stores a leader replica of the replicas. The write request can include an indicator of a tenant tⱼ associated with the write request and an indicator of the range pᵢ. In some cases, the node can receive the write request from a leaseholder node for the range and/or from a gateway node that originally received the transaction including the write request from the client device. A leaseholder node storing a leaseholder replica of the range and/or a gateway node may send the write request to the leader node. Two or more follower nodes may store two or more follower replicas of the replicas of the range, where each follower node may store a respective follower replica of the two or more follower replicas. For example, at least first and second follower nodes (e.g., nodes 120b and 120c) may store respective follower replicas of the range. The leader node may sequence the write request for evaluation and execution based on FIFO semantics and/or timestamps as described herein. In some cases, the leader node may sequence the write request for evaluation and execution using FIFO semantics, such that a first write request that is received by the leader node before a second write request is ordered for evaluation and execution before the second write request. In some cases, the leader node may sequence write requests for execution based on the timestamps associated with the write requests as described herein, such that a first write request having a first timestamp that is earlier than a second timestamp of a second write request is sequenced for evaluation and execution before the second write request. In some cases, the leader node may sequence requests for execution according to queuing techniques described further in U.S. patent application Ser. No. 18/046,693, which is hereby incorporated by reference herein in its entirety.

At step 304, the leader node may perform evaluation of the write request (also referred to as “request evaluation”) to generate a log entry based on the write request, where the log entry is configured to be appended to the respective Raft logs stored by the leader node and follower nodes. The log entry may include instructions indicating the write (e.g., updates and/or modifications) to be made to the data included in the replicas of the range, such as updates to particular data (e.g., value(s) of key(s)) stored by the range. Based on performing request evaluation, the leader node may write the log entry to the Raft log stored by the leader node. The written log entry may be assigned an index iₖ indicative of a position of the log entry within the Raft log. The leader node may order (e.g., sequence) the log entry for execution after previous log entries that were previously added to the Raft log before the log entry. In some cases, request evaluation may include acquiring locks on data (e.g., key(s) and respective value(s)) of the range that is to be modified based on the instructions included in the write request. In some cases, request evaluation may include acquiring one or more latches on data (e.g., key(s) and respective value(s)) of the range that is to be modified based on the instructions included in the write request. In some cases, request evaluation may not end (and the method may not proceed to step 306) until existing locks and/or latches applied to data to be modified based on the write request are removed and/or otherwise released by other (e.g., previous and/or on-going) write requests. In some cases, request evaluation can include reading data to be modified based on the write request. For example, request evaluation can include reading respective value(s) of key(s) to be modified based on the instructions included in the write request.

At step 306, the leader node may send the log entry to each of the follower nodes. Based on receiving the log entry, each follower node (if available) may write the log entry to their respective stored Raft log. In some cases, one or more of the follower nodes may have failed and/or otherwise be offline, such that they are unable to write the log entry to their respective stored Raft log.

At step 308, based on receiving the log entry from the leader node, each follower node may write the log entry to their respective Raft log. Each follower node that successfully wrote the log entry to their respective Raft log may send instructions to the leader node, where the instructions can include acknowledgement of the write of the log entry to the Raft log. The leader node may receive the instructions including the acknowledgements from the follower nodes.

At step 310, based on receiving the acknowledgements of the write of the log entry from at least a threshold number of the follower nodes, the leader node may modify a state of the leader replica based on the modification(s) included in the instructions of the log entry. The threshold number of nodes may be a majority number of the follower replicas minus one. For example, when the two or more follower replicas include four follower replicas (e.g., such that the consensus group includes five total replicas), the threshold number of nodes may be two follower nodes. In some cases, based on a majority number of the leader node and the follower nodes writing the log entry to their Raft log and/or seconding acknowledgements of the write, respectively, the leader node may (i) modify a state (e.g., value(s) of key(s)) of the leader replica according to the instructions included in the log entry and (ii) send a communication to the follower nodes (e.g., available follower nodes) to modify a state of the follower replicas according to the instructions included in the log entry. The follower nodes may receive the communication from the leader node and may modify, based on receiving the communication, the state of the follower replicas according to the instructions included in the log entry. Additional features for use of a consensus protocol within a commit protocol are described at least in U.S. patent application Ser. No. 18/316,851.

In some embodiments, each of the replicas stored by a particular node may be stored in a state data store of the node and Raft logs for each of the replicas stored by the node may be stored in a log data store of the node. In some cases, the state data store and the log data store of a particular store may be combined in a single shared data store (e.g., such as an LSM tree). At each node storing one or more replicas of one or more ranges, physical computing resources of the node may be shared among the state data store and the log data store, such that the node may store, for example, hundreds to thousands of ranges that share the physical computing resources of the node.

### Replication Admission Control for Write Request Processing for a Consensus Group

In some embodiments, the method 300 for processing a write request by a consensus group may execute simultaneously for a number of write requests originating from a number of tenants. Simultaneous execution of the method 300 for a number of write requests can cause high utilization of physical computing resources at individual nodes, thereby constraining performance to execute the operations of the method 300 with reduced latencies. Further, simultaneous execution of the method 300 for a number of write requests originating from a number of different tenants can cause unequal (e.g., unfair) utilization of the physical computing resources, such that first transactional operations including instructions to execute first write requests for a first tenant operates with higher performance relative to second transactional operations including instructions to execute of second write requests for a second tenant. As described herein, conventional distributed computing systems fail to account for and mitigate the overutilization of physical computing resources at nodes storing follower replicas of consensus groups. Further, conventional distributed computing systems fail to promote performance isolation between tenants and/or workloads that have ranges stored by the same node, such that tenants are provided unequal access to physical computing resources at nodes storing follower replicas of consensus groups. Accordingly, improved systems and methods are provided for controlling resource utilization for consensus-based distributed groups of replicas.

In some embodiments, to account for overutilization of physical computing resources at nodes storing follower replicas, token pools may be introduced for use among nodes of consensus groups and tenants corresponding to the consensus groups. Each token pool may correspond to attributes identifying a particular node storing a replica of a consensus group and a tenant, where the attributes identify an originating node for the write request, a replica node for the write request, and a tenant from which the write request originated. In some cases, an originating node for a write request may refer to the leader replica of the range to be written to (e.g., modified) by the write request. In some cases, a replica node for a write request can refer to one of the nodes storing a Raft log to be modified based on the instructions of the write request. As an example, the token pool for a particular originating node, replica node, and tenant associated with the replicas stored by the originating node and replica node may be represented as tokens (<originating node>, <replica node>, <tenant>). A respective token pool may be generated and replenished over time for each combination of an originating node, replica node, and tenant for a particular consensus group, where the respective token pools for each of the combinations form a group of token pools corresponding to the originating node, the nodes storing replicas of the consensus group, and the tenant. As an example, a consensus group may include replicas stored by only node 120d, node 120e, and node 120f, where (i) node 120d stores the leader replica, (ii) nodes 120e and 120f store respective follower replicas of the leader replica, and (iii) a tenant from which a write request originates is referred to as tenant1. For such a consensus group, a group of three tokens pools may exist and be used for admission control purposes, which may, for example, be defined as:
First Token Pool: tokens (<node 120d>, <node 120d>, <tenant1>)
Second Token Pool: tokens (<node 120d>, <node 120c>, <tenant1>)
Third Token Pool: tokens (<node 120d>, <node 120f>, <tenant1>)

As described herein, a token pool can be defined as corresponding to a particular node from the nodes storing replicas of a consensus group and a particular tenant, where a group of token pools for the tenant, originating node of the consensus group, and the nodes of the consensus group can be used to proceed with evaluation of a write request. Accordingly, replicas for different ranges that share the same leader replica and are stored by the same node and correspond to the same tenant can share a token pool. In the example described above, the token pool for tokens (<node 120d>, <node 120c>, <tenant1>) may be shared by all ranges associated with tenant 1 that have a leader replica stored on node 120d and a follower replica stored node 120c.

In some embodiments, additionally or alternatively to keying token pools by tenant, each token pool may correspond to attributes identifying a particular node storing a replica of a consensus group and a workload, where the attributes identify an originating node for the write request, a replica node for the write request, and a workload to which the write request is directed. In some cases, an originating node for a write request may refer to the leader replica of the range to be modified by the write request. In some cases, a replica node for a write request can refer to one of the nodes storing a Raft log to be written to (e.g., modified) based on the instructions of the write request. As an example, the token pool for a particular originating node, replica node, and workload corresponding to the replicas stored by the originating node and replica node may be represented as tokens (<originating node>, <replica node>, <workload>). A respective token pool may be generated and replenished over time for each combination of an originating node, replica node, and workload for a particular consensus group, where the respective token pools for each of the combinations form a group of token pools corresponding to the originating node, the nodes storing replicas of the consensus group, and the workload. As an example, a consensus group may include replicas stored by only node 120d, node 120c, and node 120f, where (i) node 120d stores the leader replica, (ii) nodes 120e and 120f store respective follower replicas of the leader replica, and (iii) a workload including the range to which a write request is directed is referred to as workload1. For such a consensus group, a group of three tokens pools may exist and be used for admission control purposes, which may, for example, be defined as:
First Token Pool: tokens (<node 120d>, <node 120d>, <workload1>)
Second Token Pool: tokens (<node 120d>, <node 120c>, <workload1>)
Third Token Pool: tokens (<node 120d>, <node 120f>, <workload1>)

As described herein, a token pool can be defined as corresponding to a particular node from the nodes storing replicas of a consensus group and a particular workload, where a group of token pools for the workload, originating node of the consensus group, and the nodes of the consensus group can be used to proceed with evaluation of a write request. Accordingly, replicas for different ranges that share the same leader replica and are stored by the same node and correspond to the same workload can share a token pool. In the example described above, the token pool for tokens (<node 120d>, <node 120c>, <workload1>) may be shared by all ranges included in workload1 that have a leader replica stored on node 120d and a follower replica stored node 120e. In some cases, a tenant associated with workload1 may be associated with more than one workload or only workload1. In some cases, a particular workload may only be associated with one tenant.

In some embodiments, a leader node may store and maintain the group of token pools corresponding to each of the combinations of an originating node storing a leader replica of a particular consensus group of replicas of a range, the nodes storing replicas of the particular consensus group, and a tenant (or workload) associated with the range. In some cases, a group of token pools (e.g., corresponding to an originating node, nodes of consensus group, and a tenant or workload) may include a number of token pools equivalent to a number of replicas configured to participate in the consensus protocol for committing write requests to the range. For example, for a range having five replicas (e.g., one leader replica and four follower replicas) configured to participate in a consensus protocol, a group of five token pools may exist and be used to control utilization of physical computing resources at the nodes storing the five replicas. In some cases, a size of a token pool may be defined by a number of bytes. In some cases, a size of a token pool may be defined by a number of tokens included in the token pool. In some cases, an initial size of each of the token pools for a consensus group may be fixed (e.g., at 16 MB) and the size of each of the token pools may change over time based on tokens that have been consumed from and/or replenished to the token pools. A write request may cause consumption of tokens from a token pool and may cause replenishing of tokens from a token pool as described further below. Consumption of tokens from a token pool may include removing, deducting, and/or otherwise subtracting the consumed tokens from the token pool, thereby reducing the size of the token pool (e.g., a number of available tokens). A particular token pool may range from a negative size (e.g., negative number of tokens) to a positive size (e.g., positive number of tokens). Replenishment of tokens to a token pool may include adding and/or introducing the replenished tokens to the token pool, thereby increasing the size of the token pool (e.g., a number of available tokens).

In some embodiments, as described with respect to at least the method 300, a leader node storing a leader replica for a range may receive a write request including instructions to write (e.g., modify) to data (e.g., value(s) of key(s)) included in the range. The write request can include an indicator of a tenant tⱼ associated with the write request, an indicator of the range rᵢ to be written to based on the instructions of the write request, and/or a workload including the range rᵢ to be written to based on the instructions of the write request. The leader node may determine whether to proceed to perform evaluation of the write request based on an availability (e.g., size) of each token pool of the group of token pools for the consensus group of the range and the tenant tⱼ. In some cases, the leader node may determine whether to proceed to perform evaluation of the write request by determining whether each token pool of the group of token pools corresponding to the originating node (e.g., leader node) storing a leader replica of the consensus group, the nodes storing replicas of the consensus group, and the tenant tⱼ have a size greater than a threshold size. In some cases, based on receiving the write request, the leader node may determine and/or identify a size of each token pool of the group of token pools. When the leader node determines each token pool of the group of token pools has greater than a threshold size (e.g., a size>0), the leader node may proceed to perform evaluation of the write request. When the leader node determines at least one token pool of the group of token pools do not have greater than a threshold size, the leader node may wait for each token pool of the group of token pools to have greater than a threshold size (e.g., a positive size) and may not proceed to perform evaluation of the write request. For the write request, the leader node may not consume tokens from any of the token groups prior to performing evaluation of the write request based on (i) a size of the write request being unknown before the evaluation, and (ii) the evaluation potentially blocking other write requests via lock and/or latch acquisition for data (e.g., key(s) and respective value(s)) included in the range. By delaying consumption of tokens until after request evaluation, the leader node prevents starvation of tokens from other write requests that do not require locks and/or latches to proceed to execute.

In some embodiments, the leader node may perform request evaluation by determining a size of a write request and a resulting log entry corresponding to the write request, where the size is based on (e.g., equivalent to) (i) the size of the tokens the write request is configured to cause to be consumed from each of the token pools and/or (ii) an amount and/or size of data to be modified based on the instructions of the write request. For example, the leader node may determine the write request has a size of 1 MB, such that the write request is configured to cause consumption of 1 MB from each token pool of the group of token pools for the write request. Based on (e.g., after) performing request evaluation, the leader node may cause consumption of tokens from each token pool of the group of token pools, where the consumed tokens are equivalent to the determined size of the write request. In some cases, consumption of the tokens from each token pool of the group of token pools may cause one or more token pools of the group of token pools to have a negative size (e.g., a size<0). In some cases, based on performing request evaluation, the leader node may generate and record metadata for the log entry (e.g., generated by the request evaluation) to a ledger stored at the leader node. The metadata may include identifying information for the log entry (e.g., consensus group, originating node, tenant, timestamp, workload, etc.) and may include an indication of the size of the write request and resulting log entry (e.g., as previously determined by the leader node).

In some embodiments, in addition to the steps included in the method 300, virtual admission queues may be introduced for use with the token pools for a write request. Each node storing a replica included in a consensus group may operate a virtual admission queue. Accordingly, a number of virtual admission queues used by a particular consensus group may be equivalent to a number of replicas of a range configured to participate in the consensus protocol for committing write requests to the range. In some cases, virtual admission queues may be referred to as “virtual” based on not impacting execution of the consensus protocol as described at least with respect to the method 300. For example, a virtual admission queue may not impact or prevent on-going write requests (e.g., write requests that have started and completed request evaluation) from executing, but may prevent and/or delay write requests from performing request evaluation at a leader node associated with the virtual admission queue (e.g., by consensus group). A virtual admission queue may be used to (i) track tokens consumed from token pools corresponding to nodes storing replicas of a consensus group and (ii) cause replenishment of consumed tokens to a particular token pool corresponding to a log entry admitted from the virtual admission queue. For example, for a virtual admission queue operating at a follower node and queuing metadata for a log entry including instructions to write to a particular follower replica of a consensus group, the virtual admission queue may cause replenishment of tokens to the token pool corresponding to an originating node for the consensus group, the follower node storing the follower replica, and the tenant from which the write request originated (e.g., by sending a communication to the leader replica to add tokens to the token pool).

In some embodiments, based on the generation of metadata for a log entry, a leader node may (i) add the metadata to a virtual admission queue operating at the leader node, and (ii) send the metadata to each of the follower nodes storing follower replicas of the range that operate respective virtual admission queues. At each virtual admission queue, a node may queue metadata for respective log entries added to the Raft log(s) (e.g., each corresponding to a replica of a consensus group) stored at the node. A node may queue metadata for log entries corresponding to a number of different replicas of ranges in the individual virtual admission queue operated by the node, where the ranges can correspond to a number of tenants (e.g., different tenants) and/or workloads (e.g., different workloads). A node may dequeue and admit metadata for a particular log entry corresponding to a particular Raft log from the virtual admission queue operating at the node based on one or more parameters. The one or more parameters may include utilization (e.g., mean utilization over a selected time period) of physical computing resources (e.g., CPU, non-volatile storage, volatile memory, etc.) at the node, a type of the physical computing resources at the node, and the tolerated latencies supported by workloads stored by the cluster (e.g., cluster 102) of nodes. In some cases, a node may dequeue and admit metadata for a particular log entry from the virtual admission queue operating at the node based on a comparison of a mean utilization of one or more physical computing resources of the node to a threshold utilization value. In some cases, the threshold utilization may range from 50% to 95% utilization. As an example, based on a utilization of one or more of the physical computing resources of a node being less than a threshold utilization (e.g., less than a threshold percentage utilization), the node may dequeue and admit metadata for log entries from the virtual admission queue at a first rate (e.g., 10 MB per second). As another example, based on a utilization of one or more of the physical computing resources of a node being greater than a threshold utilization (e.g., greater than a threshold percentage utilization), the node may dequeue and admit metadata for log entries from the virtual admission queue at a second rate (e.g., 1 MB per second) lower than the first rate.

In some embodiments, a threshold utilization of one or more physical computing resources at a node used to control (e.g., limit) a rate at which metadata is dequeued from a virtual admission queue operating at the node may be based on a type of the physical computing resources at the node (e.g., CPU, non-volatile storage, or volatile memory) and the tolerated latencies supported by workloads stored by the cluster (e.g., cluster 102) of nodes. Generally, a workload that can tolerate higher latencies for executing write requests may be able to tolerate higher threshold utilization values without requiring limiting rates for dequeuing of metadata from virtual admission queues operated by nodes storing replicas of ranges included in the workload. As an example, for a particular workload requiring less than 10 millisecond (ms) write latencies and when a range of the workload is receiving write requests at a millisecond granularity for a replica stored by a particular node, the node may experience 5 ms or greater queue times for metadata in the virtual admission queue even when mean utilization of the CPU of the node is 60%. To maintain 10 millisecond write latencies, the node may limit dequeuing of metadata from the virtual admission queue based on the 60% utilization of the CPU exceeding a threshold utilization value. As another example, for a particular workload requiring less than 500ms write latencies and when a range of the workload is receiving write requests at a millisecond granularity for a replica stored by a particular node, the node may experience 5 ms or greater queue times for metadata in the virtual admission queue even when mean utilization of the CPU of the node is 60%. Accordingly, the node may not need to limit dequeuing of metadata (e.g., at a slower rate) from the virtual admission queue and may allow CPU utilization to significantly exceed 60% utilization (e.g., 85% utilization) based on the workload tolerating increased write latencies.

In some embodiments, an order in which a node may dequeue metadata for log entries from the virtual admission queue may be based on one or more of: inter-tenant fairness, inter-workload fairness, priority levels of write requests corresponding to the queued metadata, and timestamps of write requests corresponding to the queued metadata. In some cases, a node may dequeue metadata for log entries from a virtual admission queue at a selected rate (e.g., 1 MB per second) on a per-tenant basis and/or a per-workload basis. As an example, a node may dequeue metadata for log entries from a virtual admission queue at the node at a selected rate (e.g., 1 MB per second) for each tenant, such that metadata for log entries corresponding to different tenants are dequeued from the virtual admission queue at approximately the same rate based on the ordering of the metadata in the virtual admission queue to ensure inter-tenant fairness. As another example, a node may dequeue metadata for log entries from a virtual admission queue at the node at a selected rate (e.g., 1 MB per second) for each workload, such that metadata for log entries corresponding to different workloads are dequeued from the virtual admission queue at approximately the same rate based on the ordering of the metadata in the virtual admission queue to ensure inter-workload fairness. In some cases, for a particular tenant and/or workload, an order in which a node may sequence and dequeue metadata for log entries for a particular tenant and/or particular workload (e.g., intra-tenant and/or intra-workload) from a virtual admission queue at the node may be based on priority levels, timestamps, and/or FIFO semantics of the metadata for the log entries. As a first example, the node may dequeue metadata having a first priority level before dequeuing metadata having a second priority level, where the first priority level is greater than the second priority level. As a second example, the node may dequeue metadata having a first timestamp before dequeuing metadata having a second timestamp, where the first timestamp is before the second timestamp. As a third example, the node may dequeue first metadata from the virtual admission queue before dequeuing second metadata, where the first metadata was added to the virtual admission queue before the second metadata. As described herein, metadata for a log entry may have a timestamp equivalent to the assigned timestamp for the transaction from which the log entry was derived. Some additional examples of techniques for queuing and dequeuing in an admission queue that may be used for queuing and dequeuing the metadata for log entries from a virtual admission control are described further in U.S. patent application Ser. No. 18/320,671, which is hereby incorporated by reference herein in its entirety.

In some embodiments, when metadata for a particular log entry is dequeued from a virtual admission queue operating at a node (e.g., follower node), the node may send dequeuing instructions to the leader node from which the log entry originates, where the dequeuing instructions include (i) an indication the metadata was dequeued (e.g., admitted) from the virtual admission queue, and (ii) an instruction to replenish (e.g., add) tokens to the token pool corresponding to the originating node, the replica node operating the virtual admission queue, and the tenant from which write request identified by the metadata originated, where the added tokens have a size equivalent to the size of the write request identified by the metadata. The dequeuing instructions may be configured to replenish tokens consumed by the write request (e.g., identified by the metadata) by causing addition of the tokens to the token pool indicated by the dequeuing instructions. The leader node may receive the dequeuing instructions and may (i) replenish (e.g., add) the tokens in the token pool indicated by the dequeuing instructions and (ii) record the addition of the tokens to the token pool in the ledger stored on the leader node. In some cases, dequeuing instructions sent to a leader node may be included within an existing message between a follower node and a leader node. For example, dequeuing instructions may be included in a message sent from a follower node to a leader node as a part of the consensus protocol for a write request. In some cases, to promote receipt of dequeuing instructions by originating nodes (e.g., leader nodes) in the cluster, replica nodes (e.g., follower nodes) may send dequeuing instructions to the originating node via a more reliable connection stream (e.g., Transmission Control Protocol (TCP)). When metadata for a particular log entry is dequeued from a virtual admission queue operating at a leader node, the leader node may (i) replenish the tokens in the token pool and (ii) record the addition of the tokens to the token pool in the ledger without the use of dequeuing instructions. Based on replenishment of tokens to the token pool, the leader node may re-determine (e.g., periodically or continuously) whether each token pool of the group of token pools have a positive size to perform request evaluation for additional write requests. While some embodiments of a group of token pools are described herein as being associated with an originating node, replica node, a tenant, in some cases, the token pools may additionally or alternatively be defined as associated with an originating node, replica node, workload corresponding to a tenant, where the workload includes the range to be written to based on the instructions of the write request.

In some embodiments, the above-described techniques for use of token pools and virtual admissions queues can provide performance isolation between tenants and/or workloads having replicas stored on the same nodes. As an example, a consensus group may include only node 120d, node 120e, and node 120f, where (i) node 120d stores a leader replica of a range, (ii) nodes 120c and 120f store respective follower replicas of the range, and (iii) a tenant from which a write request originates is referred to as tenant2. The node 120e may face high utilization of physical computing resources and may determine to limit execution of write requests corresponding to tenant2 directed to the range (e.g., originating at node 120d) at a rate of 1 MB per second, while tenant2 is causing generation of write requests directed to the node at a rate of 5 MB per second. If the token pool (e.g., tokens (<node 120d>, <node 120c>, <tenant2>)) for node 120e had an initial size of 16 MB, 4 seconds after limiting execution of the write requests, 20 MB of tokens from the token pool would be consumed by the write requests and only 4 MB of tokens would be replenished to the token pool, such that the token pool has a size of 0 MB. Accordingly, despite tenant2 causing generation of write requests directed to the node at a rate of 5 MB per second, leader node can be required to wait for at least the token pool to have a positive size before proceeding with request evaluation for the generated write requests. By causing the leader node to wait to proceed with request evaluation, the write requests originating at node 120d and directed to the range are effectively executed at a rate of 1 MB per second.

In some embodiments, a write request may include a priority indicator indicating a priority level (e.g., high, medium, or low priority) of one or more priority levels. The priority indicator for a write request may correspond to the write request's priority for the particular tenant associated with the request and/or the workload to which the write request includes instructions for writing. A priority level indicated by the priority indicator may be a quantitative or categorical representation of priority. In some cases, priority indicators may only be compared on an intra-tenant basis, such that priority indicators of write requests corresponding to different tenants cannot be compared and used for queueing inter-tenant requests. Priority indicators of write requests associated with a tenant (or workload) can enable starvation for lower priority write requests, such that when higher priority write requests corresponding to a particular tenant are consuming available physical computing resources, the lower priority write requests corresponding to the same tenant (or workload) can wait for an indefinite amount of time for execution via the consensus protocol.

In some embodiments, a group of token pools for each combination of an originating node, replica node, and tenant from which a write request originated may exist for one or more priority levels, such that separate token pools within the group of token pools may exist and be used for different priority levels that may be assigned to write requests. When write requests for a tenant may have a priority indicator indicative of two or more priority levels for a tenant, each priority level may correspond to a respective token pool for tokens (<originating node>, <replica node>, <tenant>). A number of token pools included in a group of token pools may be equivalent to a number of replicas configured to participate in the consensus protocol for committing write requests to the range multiplied by a number of priority levels that may be indicated by a write request originating from the tenant. For example, for a range having five replicas (e.g., one leader replica and four follower replicas) configured to participate in a consensus protocol and a write request can indicate a high or low priority level for a tenant, a group of token pools may include ten token pools that are used to control utilization of physical resources at the nodes storing the five replicas.

As an example of use of priority for token pools, a consensus group may include only node 120d, node 120c, and node 120f, where (i) node 120d stores a leader replica of a range, (ii) nodes 120e and 120f store respective follower replicas of the range, and (iii) a tenant from which a write request originates is referred to as tenant2, and (iv) write requests originating from tenant2 may indicate a first (e.g., low) priority level or second (e.g., high) priority level, where the second priority level has higher priority than the first priority level. For a particular write request directed to replicas of a range stored by nodes of the consensus group, the leader node may determine whether to proceed to perform evaluation of the write request by determining whether each token pool of the group of token pools token pools corresponding to the originating node, replica node, the tenant tⱼ, and the priority level of the write request have a positive size. When the leader node determines each of the token pools include a positive size (e.g., a size>0), the leader node may proceed to perform evaluation of the write request. Based on (e.g., after) performing request evaluation, the leader node may cause consumption of tokens from each token pool of the group of token pools corresponding to the priority levels having a priority level that is less than or equal to the priority level of the write request. In the example described above, after a leader node performs evaluation of a write request with the second priority level, the leader node may cause consumption of tokens (e.g., tokens having the determined size of the write request) from each token pool of the group of token pools corresponding to the first and the second priority levels, such that tokens are deducted from the token pools corresponding to both the first and second priority levels. Such techniques ensure that lower priority write requests are not prioritized and processed via the consensus protocol at a rate higher than a rate at which high priority write requests are processed. Further, if the write request in the example described above indicated the first priority level, after a leader node performs evaluation of a write request with the first priority level, the leader node may cause consumption of tokens from each token pool of the group of token pools corresponding to the first priority level, such that tokens are deducted from only the token pools of the group that correspond to the first priority level and tokens are retained in the token pools of the group that correspond to the second priority level.

In some embodiments, node failures may occur, such that replicas stored by the failed nodes are unavailable for a period of time. In some cases, the replicas stored on failed nodes may be replaced onto other, available nodes of the cluster, but a period of time may exist between a node failure and replacement of the replicas that were stored by the failed nodes onto other, available nodes. Further, a leader replica for a particular range can change to a follower replica, such that a previous leader replica becomes a follower replica and a previous follower replica becomes a leader replica. Accordingly, the ledger stored at the leader node may be used to record changes to nodes storing a leader replica and/or follower replica of a range, as well track updates to a size of token pools for nodes storing replicas of a consensus group.

In some embodiments, an originating node (e.g., leader node) for a write request may determine that a particular replica node (e.g., follower node) has failed or is otherwise unavailable (e.g., based on an underlying liveness system used to identify whether a node is operating or failed). Based on the originating node determining the replica node has failed, the originating node may (i) cause the tokens that are presently consumed from the token pool (e.g., corresponding to write requests and resulting log entries that have metadata that has not been dequeued from a virtual admission queue at the failed node) to be added to the token pool and (ii) record metadata to the ledger stored by the originating node indicating the addition of the tokens. The originating node may remove, from the ledger, the metadata for the write requests and resulting log entries corresponding to the tokens that are presently consumed from the token pool, thereby balancing the size of the token pools via the ledger. When the originating node receives dequeuing instructions from another node (e.g., a replica node) including an indication to replenish tokens to a particular token pool, the originating node may determine whether to replenish tokens to the particular token pool based on whether the ledger indicates the tokens as consumed from the token pool by the write request corresponding to the dequeuing instructions. When the ledger does indicate the tokens as consumed from the token pool, the originating node may proceed to add the tokens to the token pool as indicated by the dequeuing instructions. When the ledger does not indicate the tokens as consumed from the token pool, the originating node may ignore the dequeuing instructions (e.g., based on previously adding the tokens to the token pool).

In some embodiments, an originating node (e.g., leader node) for a write request may determine that at least a threshold number of dequeuing instructions have not been received within at least a threshold amount of time. Based on the originating node determining at least a threshold number of dequeuing instructions have not been received within at least a threshold amount of time, the originating node may (i) cause the tokens that are presently consumed from the token pool (e.g., corresponding to write requests and resulting log entries that have metadata that has not been dequeued from a virtual admission queue) to be added to the token pool and (ii) record metadata to the ledger stored by the originating node indicating the addition of the tokens. The originating node may remove, from the ledger, the metadata for the write requests and resulting log entries corresponding to the tokens that are presently, thereby balancing the size of the token pools via the ledger.

In some embodiments, an leader node for a write request may determine that the leader replica for the range to be modified based on instructions of the write request is no longer stored by the leader node (e.g., based on a change the node storing the leader replica). Based on the originating node determining the leader replica for the range to be modified based on instructions of the write request is no longer stored by the originating node, the originating node may (i) cause the tokens that are presently consumed from the token pool (e.g., corresponding to write requests and resulting log entries that have metadata that has not been dequeued from a virtual admission queue) to be added to the token pool and (ii) record metadata to the ledger stored by the originating node indicating the addition of the tokens. The originating node may remove, from the ledger, the metadata for the write requests and resulting log entries corresponding to the tokens that are presently, thereby balancing the size of the token pools via the ledger. In some cases, when the leader node sends log entries to follower nodes and instructions for the follower nodes to write the log entries to their response Raft logs, the messages including the log entries and instructions may be dropped and may not reach the follower nodes. Accordingly, the leader node may resend the messages including the log entries and instructions when the messages are dropped.

### Exemplary Method for Write Request Processing for a Consensus Group Using Admission Control

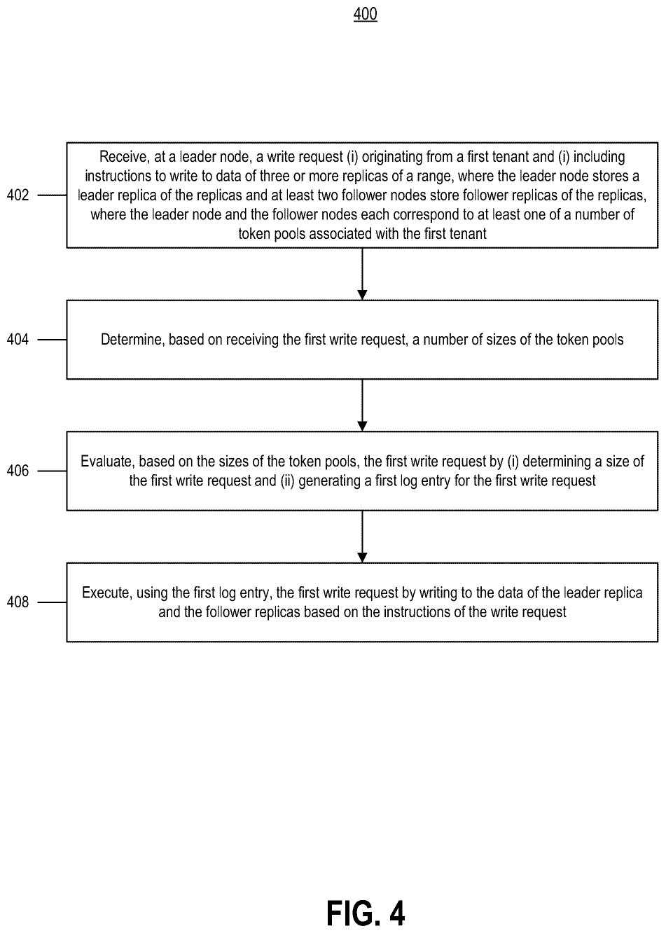

In some embodiments, as described herein, the nodes storing replicas of a consensus group for a particular e.g., range may execute a consensus protocol using admission control techniques (e.g., use of a group of token pools and virtual admission queues) to commit write requests to the replicas of the range. The consensus group can include the leader replica and the follower replicas of the range, which form the voting replicas of the range. Each range has a respective consensus group and Raft log used to commit requests to the replicas of the range, where a group of token pools correspond to (i) the nodes storing replicas of the consensus group and (ii) a tenant (and/or workload) associated with the range. Referring to FIG. 4, an exemplary flowchart of a method 400 for processing a write request using a consensus protocol and admission control techniques is illustrated. While the method 400 is described with respect to a single write request directed to a range replicated among at least three replicas, the method 400 may be executed in parallel (e.g., simultaneously) by a number of consensus groups stored by the cluster (e.g., cluster 102) for a number of write requests and increased numbers of replicas may be included in a consensus group to provide additional tolerance to node failures. A client device 106 may send the write request to the cluster 102 as a part of a transaction including one or more requests. A gateway node may receive and assign a timestamp to the transaction as described herein and may route the write request to a leaseholder node storing the leaseholder replica for a range to which the write request is directed. In some cases, the leaseholder replica may also be the leader replica for the range.

At step 402, a leader node (e.g., node 120a) storing a leader replica for a range can receive a first write request (i) originating from a first tenant and (ii) including instructions to write to (e.g., modify) data of the range. The first write request can include an indicator of a tenant and/or a workload associated with the first write request and an indicator of the range. In some cases, the leader node can receive the first write request from a leaseholder node for the range and/or from a gateway node that originally received the transaction including the first write request from a client device associated with the tenant. A leaseholder node storing a leaseholder replica of the range and/or a gateway node may send the first write request to the leader node. In other cases, the leader node may be the leaseholder node, such that the leader replica of the range is also the leaseholder replica of the range. Two or more follower nodes may store two or more follower replicas of the range, where each follower node may store a respective follower replica of the two or more follower replicas. For example, at least first and second follower nodes (e.g., nodes 120b and 120c) may store respective follower replicas of the range. The leader node and the follower nodes may each use a respective token pool of a group of token pools corresponding to the nodes storing the replicas of the consensus group and a first tenant. As described herein, the group of token pools may include the token pools corresponding to each combination of an originating node (e.g., leader node), replica node (e.g., leader node or follower node), and tenant for a particular consensus group. In some cases, the first write request can originate from the first tenant based on the first write request originating from a client device associated with the first tenant. The leader node may store the group of token pools as described herein. In some cases, the group of token pools may further correspond to a first workload operated by the first tenant, where the first tenant operates one or more workloads each including one or more ranges. In some cases, the group of token pools may include the token pools corresponding to each combination of an originating node (e.g., leader node), replica node (e.g., leader node or follower node), tenant for a particular consensus group, and a priority level that can be included in the first write request.

At step 404, the leader node may determine, based on receiving the first write request, the size of each token pool of the group of token pools. Each of the token pools may have a size based on whether tokens have been deducted from the token pools by other write requests corresponding to the token pools (e.g., directed to replicas of ranges associated with the tenant and stored by the leader node and follower nodes). Based on determining the sizes of the token pools of the group of token pools, the leader node may compare each of the sizes to a threshold size (e.g., 0 bytes) to determine whether to proceed with evaluation of the first write request or wait for each of the sizes of the token pools to be greater than the threshold size.

At step 406, the leader node may evaluate, based each of the sizes of the token pools of the group being greater than the threshold size, the first write request by (i) determining a size of the first write request and (ii) generating a first log entry for the first write request. Evaluation of the first write request may include a number of operations as described herein at least with respect to the method 300. Based on evaluating the first write request, the leader node may (i) deduct the size of the first write request from each token pool of the group of token pools and (ii) record first metadata for the first log entry in a ledger stored by the leader node. The first metadata may include identifying information for the first write request (e.g., associated tenant, workload, and range, timestamp, etc.) and an indication of the size of the first write request.

At step 408, the leader node and the follower nodes may execute, based on the evaluation of the write request (e.g., at step 406) and using the first log entry, the first write request by writing to the data of the leader replica and the follower replicas of the range. To execute the first write request, the leader node may write the first log entry to a write (e.g., Raft) log of the leader node and may send the first log entry to each of the follower nodes storing a follower replica configured to participate in the consensus protocol, where the first log entry includes an indication of the first write request (e.g., instructions included in the first write request for writing to the data of the replicas). The follower nodes may receive the first log entry and may write the first log entry to the their respective write (e.g., Raft) logs. In some cases, one or more of the follower nodes storing the follower replicas may have failed, such that the follower nodes are unavailable and may not write the first log entry to their respective write logs. Based on writing the first log entry to the their respective write (e.g., Raft) logs, the follower nodes may send acknowledgement of writing the first log entry to the leader node. Based on a majority of the leader node and the follower nodes writing (e.g., recording) the first log entry to a respective write (e.g., Raft) log stored by each of the leader node and the follower nodes, the leader node and the follower nodes may write (e.g., modify) the data of the leader replica and the follower replicas based on the first log entry. For example, the leader node may send instructions to the follower nodes to write to the data of the follower replicas based on the instructions of the first log entry and the first write request. Execution of the write request may include a number of operations as described herein at least with respect to the method 300.

In some embodiments, based on the leader node (i) writing the first log entry to a write (e.g., Raft) log, (ii) deducting the size of the first write request from each token pool of the group of token pools, and/or (iii) recording the first metadata for the first log entry in the ledger, the leader node may queue the first metadata for the first log entry in an virtual admission queue operated by the leader node. The virtual admission queue may be configured to queue metadata for a number of log entries written to write log(s) stored by the leader node and corresponding to one or more tenants and/or one or more workloads, where the metadata for the number of log entries includes the first metadata for the first log entry, and where the one or more tenants include the first tenant. The leader node may dequeue the first metadata for the first log entry from the virtual admission queue based on the utilization of the physical resources of the leader node. The physical resources may include one or more of: a processor, non-volatile storage, and volatile memory. The leader node may add, based on the dequeuing, the size of the first write request to the token pool corresponding to the leader node. The virtual admission queue operated by the leader node may order the metadata for the number of log entries for dequeuing based on at least one of: (i) a respective priority level of each the number of log entries, and (ii) a respective priority of each of the one or more tenants.

In some embodiments, based on a first follower node of the follower nodes (i) receiving and/or writing the first log entry to a write (e.g., Raft) log of the first follower node, the first follower node may queue the first metadata for the first log entry in an virtual admission queue operated by the first follower node. The virtual admission queue may be configured to queue metadata for a number of log entries written to write log(s) stored by the first follower node and corresponding to one or more tenants and/or one or more workloads, where the metadata for the number of log entries includes the first metadata for the first log entry, and where the one or more tenants include the first tenant. The first follower node may dequeue the first metadata for the first log entry from the virtual admission queue based on the utilization of the physical resources of the first follower node. The physical resources may include one or more of: a processor, non-volatile storage, and volatile memory. The first follower node may send, to the leader node and based on the dequeuing, instructions configured to cause addition of the size of the first write request to the token pool corresponding to the first follower node. The leader node may receive the instructions and may add the size of the first write request to the token pool corresponding to the first follower node. The virtual admission queue operated by the first follower node may order the metadata for the number of log entries for dequeuing based on at least one of: (i) a respective priority level of each the number of log entries, and (ii) a respective priority of each of the one or more tenants. Each of the follower nodes storing a follower replica included in the consensus group that is available (e.g., not failed or unavailable) may perform the above-described operations with respect to receiving the first log entry and queuing and dequeuing metadata for the first log entry in a respective virtual admission queue operated by the follower node.

### Further Description of Some Embodiments

FIG. 5 is a block diagram of an example computer system 500 that may be used in implementing the technology described in this document. General-purpose computers, network appliances, mobile devices, or other electronic systems may also include at least portions of the system 500. The system 500 includes a processor 510, a memory 520, a storage device 530, and an input/output device 540. Each of the components 510, 520, 530, and 540 may be interconnected, for example, using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, etc.). The input/output device 540 provides input/output operations for the system 500. In some implementations, the input/output device 540 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, for example as a server farm or a set of widely distributed servers, or may be implemented in a single computing device.

Although an example processing system has been described in FIG. 5, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.c., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.c., elements that are conjunctively present in some cases and disjunctively present in other cases. Multiple elements listed with “and/or” should be construed in the same fashion, i.c., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.c., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for controlling execution of distributed operations, the method comprising:
receiving, by a leader node of a plurality of nodes, a first write request (i) originating from a first tenant and (ii) comprising first instructions to write to data of three or more replicas of a first range, wherein the leader node stores a leader replica of the replicas, wherein at least two follower nodes of the nodes each store a follower replica of the replicas, wherein the leader node is configured to coordinate a consensus protocol for executing the first instructions of the first write request, wherein the leader node and the follower nodes each correspond to at least one of a plurality of token pools associated with the leader node, the follower nodes, and the first tenant;
determining, based on receiving the first write request, a plurality of sizes of the token pools;
evaluating, based on the sizes of the token pools, the first write request by (i) determining a size of the first write request and (ii) generating a first log entry for the first write request; and
executing, using the first log entry, the first write request by writing to the data of the leader replica and the follower replicas based on the first instructions.

2. The method of claim 1, wherein the first write request originates from a client device associated with the first tenant.

3. The method of claim 1, wherein the leader node stores the token pools corresponding to the leader node and the follower nodes.

4. The method of claim 1, wherein the token pools correspond to a first workload including one or more ranges stored by the nodes, wherein the one or more ranges comprise the first range.

5. The method of claim 1, further comprising:
comparing the sizes of the token pools to a threshold size, wherein the evaluating the first write request further comprises evaluating the first write request when each of the sizes is greater than the threshold size.

6. The method of claim 1, further comprising:
deducting, based on the evaluation of the first write request, the size of the first write request from each of the token pools.

7. The method of claim 1, further comprising:
recording first metadata for the first log entry in a ledger stored by the leader node, wherein the first metadata comprises an indication of the size of the first write request.

8. The method of claim 1, wherein the leader node operates an admission queue, wherein the size of the at least one token pool corresponding to the leader node is based on a utilization of physical resources of the leader node, and further comprising:
queueing first metadata for the first log entry in the admission queue, wherein the admission queue is configured to queue metadata for a plurality of log entries corresponding to one or more tenants, wherein the metadata for the plurality of log entries comprises the first metadata for the first log entry, and wherein the one or more tenants comprise the first tenant;
dequeuing the first metadata for the first log entry from the admission queue based on the utilization of the physical resources of the leader node; and
adding, based on the dequeuing, the size of the first write request to the at least one token pool corresponding to the leader node.

9. The method of claim 8, wherein the physical resources of the leader node comprise one or more of: a processor, non-volatile storage, and volatile memory.

10. The method of claim 8, wherein the admission queue is configured to order the metadata for the plurality of log entries for dequeuing based on at least one of: (i) a respective priority level of each the plurality of log entries, and (ii) a respective priority of each of the one or more tenants.

11. The method of claim 1, wherein a first follower node of the follower nodes operates an admission queue, wherein the size of the at least one token pool corresponding to the first follower node is based on a utilization of physical resources of the first follower node, and further comprising:
queueing first metadata for the first log entry in the admission queue, wherein the admission queue is configured to queue metadata for a plurality of log entries corresponding to one or more tenants, wherein the metadata for the plurality of log entries comprises the first metadata for the first log entry, and wherein the one or more tenants comprise the first tenant;
dequeuing the first metadata for the first log entry from the admission queue based on the utilization of the physical resources of the first follower node;
sending, from the first follower node to the leader node and based on the dequeuing, second instructions configured to cause addition of the size of the first write request to the at least one token pool corresponding to the first follower node;
receiving, by the leader node, the second instructions; and
adding, based on the receipt of the second instructions, the size of the first write request to the at least one token pool corresponding to the first follower node.

12. The method of claim 11, wherein the physical resources of the first follower node comprise one or more of: a processor, non-volatile storage, and volatile memory.

13. The method of claim 11, wherein the admission queue is configured to order the metadata for the plurality of log entries for dequeuing based on at least one of: (i) a respective priority level of each the plurality of log entries, and (ii) a respective priority of each of the one or more tenants.

14. The method of claim 11, further comprising:
adding, based on a failure of the first follower node, the size of the first write request to the at least one token pool corresponding to the first follower node.

15. The method of claim 1, wherein the executing the first write request further comprises:
sending, from the leader node to the follower nodes, the first log entry, wherein the first log entry comprises an indication of the first instructions of the first write request; and
based on a majority of the leader node and the follower nodes recording the first log entry to a respective write log stored by each of the leader node and the follower nodes, writing to the data of the leader replica and the follower replicas based on the first log entry.

16. A system for controlling execution of distributed operations, the system comprising:
a plurality of nodes configured to perform operations comprising:
receiving, by a leader node of the nodes, a first write request (i) originating from a first tenant and (ii) comprising first instructions to write to data of three or more replicas of a first range, wherein the leader node stores a leader replica of the replicas, wherein at least two follower nodes of the nodes each store a follower replica of the replicas, wherein the leader node is configured to coordinate a consensus protocol for executing the first instructions of the first write request, wherein the leader node and the follower nodes each correspond to at least one of a plurality of token pools associated with the leader node, the follower nodes, and the first tenant;
determining, based on receiving the first write request, a plurality of sizes of the token pools;
evaluating, based on the sizes of the token pools, the first write request by (i) determining a size of the first write request and (ii) generating a first log entry for the first write request; and
executing, using the first log entry, the first write request by writing to the data of the leader replica and the follower replicas based on the first instructions.

17. The system of claim 16, wherein the first write request originates from a client device associated with the first tenant.

18. The system of claim 16, wherein the leader node stores the token pools corresponding to the leader node and the follower nodes.

19. The system of claim 16, wherein the token pools correspond to a first workload including one or more ranges stored by the nodes, wherein the one or more ranges comprise the first range.

20. The system of claim 16, wherein the operations further comprise:
comparing the sizes of the token pools to a threshold size, wherein the evaluating the first write request further comprises evaluating the first write request when each of the sizes is greater than the threshold size.
